(19) United States
(12) Patent Application Publication
(10) Pub. No.: US 2012/0262806 A1
(43) Pub. Date: Oct. 18, 2012

(54) OPTICAL IMAGE LENS ASSEMBLY

(75) Inventor: Hsin-Hsuan Huang, Taichung City (TW)

(73) Assignee: LARGAN PRECISION CO., LTD., Taichung City (TW)

(21) Appl. No.: 13/166,403

(22) Filed: Jun. 22, 2011

(30) Foreign Application Priority Data
Apr. 13, 2011 (TW) 100112759

(51) Int. Cl. G02B 9/12

(52) U.S. Cl. 359/784

(57) ABSTRACT

This invention provides an optical image lens assembly in order from an object side to an image side comprising: a first lens group has a first lens element with positive refractive power; a second lens group has a second lens element with negative refractive power; and a third lens group has at least three lens elements with refractive power; wherein a lens element in the third lens group closest to an image plane has negative refractive power and a concave image-side surface; wherein while a distance between an imaged object and the optical image lens assembly changes from far to near, focusing is performed by moving the second lens group along the optical axis toward the image plane. By such arrangement and focusing adjustment method, good image quality is achieved and less power is consumed.

### CROSS-REFERENCE TO RELATED APPLICATIONS

This non-provisional application claims priority under 35 U.S.C. §119(a) on Patent Application No. 100112759 filed in Taiwan, R.O.C. on Apr. 13, 2011, the entire contents of which are hereby incorporated by reference.

### BACKGROUND OF THE INVENTION

1. Field of the Invention

The present invention relates to an optical image lens assembly, and more particularly, to a compact optical image lens assembly used in electronic products.

2. Description of the Prior Art

A sensor of a general photographing camera is none other than CCD (charge coupled device) or CMOS device (Complementary Metal Oxide Semiconductor device). In recent years, with the popularity of mobile phones equipped with camera, the demand for compact photographing lenses is increasing. Furthermore, as advanced semiconductor manufacturing technology has allowed the pixel size of sensors to be reduced and compact photographing lenses have gradually evolved toward higher megapixels.

A conventional compact photographing lens equipped in a mobile phone is usually a single focus lens having a fixed focal length. For a specific object distance, since the photographing lens has a limited depth of field, it is apt to produce blurred images. Therefore, as the resolution of compact photographing lenses increases, a focusing adjustment function becomes more and more indispensable as well.

As the system with five lens elements disclosed in U.S. Pat. No. 7,864,454, which is designed to perform focusing by the movement of the whole lens system, has a limited depth of field while focusing at an extremely close site and thereby obtains blur peripheral images resulting in deficiency in image quality. Moreover, as the one disclosed in U.S. Pat. No. 7,777,972; wherein the invention is an image lens system with a structure of two lens groups. However, the second lens group thereof is configured with only three lens elements and thereby the ability to correct aberration and chromatic aberration is not enough.

In addition, generally, a photographing lens with focusing adjustment function performs focusing adjustment by using a driving motor to move the entire photographing lens relative to the sensor. However, such a photographing lens requires higher power consumption because the driving motor is configured to drive the entire photographing lens. Moreover, the photographing lens has a relatively long total track length.

In view of this, there is a constant demand in the industry for an optical image lens assembly, which has a lower driving power consumption of focusing and a better control of the total optical track length thereof.

### SUMMARY OF THE INVENTION

The present invention provides an optical image lens assembly comprising, in order from an object side to an image side: a first lens group comprising a first lens element with positive refractive power; a second lens group comprising a second lens element with negative refractive power; and a third lens group comprising at least three lens elements with refractive power; wherein a lens element closest to an image plane in the third lens group has negative refractive power and a concave image-side surface; wherein while a distance between an imaged object and the optical image lens assembly changes from far to near, focusing is performed by moving the second lens group along an optical axis toward the image plane; wherein there are no more than seven lens elements with refractive power in the optical image lens assembly; a focal length of the optical image lens assembly is f, a focal length of the first lens element is f1, and they satisfy the following relations: 0.8<f/f1<2.0.

On the other hand, the present invention provides an optical image lens assembly comprising, in order from an object side to an image side: a first lens group comprising a first lens element with positive refractive power having a convex object-side surface; a second lens group comprising a second lens element with negative refractive power having a concave image-side surface; and a third lens group comprising at least three lens elements with refractive power; wherein a lens element closest to an image plane in the third lens group has negative refractive power, a concave image-side surface and at least one inflection point is form on the image-side surface thereof; wherein the third lens group also comprises a lens element with positive refractive power having a concave object-side surface and a convex image-side surface, which is adjacent to an object-side surface of the lens element in the third lens group closest to the image plane; wherein while a distance between an imaged object and the optical image lens assembly changes from far to near, focusing is performed by moving the second lens group along an optical axis toward the image plane; wherein there are no more than seven lens elements with refractive power in the optical image lens assembly; a difference of the focal lengths of the optical image lens assembly between the second lens element is at the closest and the farthest position to the image plane is ^{Δ}f, the focal length of the optical image lens assembly is f, and they satisfy the following relations: |^{Δ}f/f|<0.1.

By such arrangement and focusing adjustment method, good image quality is achieved and less power is consumed.

The optical image lens assembly of the present invention has the ability to perform focusing by the movements among lens groups, wherein the movable second lens group results in excellent consequence for image quality captured at an extremely close position or an extremely far position. Moreover, since only the second lens group is moved, the power consumption for focusing is less, and it is favorable for a better control of the total optical track length.

In the aforementioned optical image lens assembly, the first lens element has positive refractive power, which thereby can reduce the total track length favorably. The second lens element has negative refractive power, and thereby the aberration of the system can be effectively corrected and the image quality thereof can be favorably improved. When a lens element closest to an image plane in the third lens group has negative refractive power, the high order aberration of the assembly can be effectively corrected. When a lens element, which is adjacent to an object-side surface of the lens element closest to an image plane in the third lens group, has positive refractive power, the total track length of the assembly can be effectively shortened and the sensitivity thereof can be also reduced.

In the aforementioned optical image lens assembly, when the first lens element has a convex object-side surface, the positive refractive power of the lens elements can be strengthened and thereby the total track length of the assembly can be reduced even more. When the second lens element has a concave image lens element, the aberration of the assembly can be corrected favorably. When a lens element, which is adjacent to an object-side surface of the lens element closest to an image plane in the third lens group, is a meniscus lens element with a concave object-side surface and a convex image-side surface, the astigmatism of the assembly can be corrected favorable. When a lens element closest to an image plane in the third lens group has a concave image-side surface, the principle point can be positioned away from the image plane and thereby reducing the total track length of the assembly.

### BRIEF DESCRIPTION OF THE DRAWINGS

FIG. 1A shows an optical image lens assembly in accordance with a first embodiment of the present invention.

FIG. 1B shows the aberration curves of the first embodiment of the present invention as a distance between the assembly and an imaged object is infinite.

FIG. 1C shows the aberration curves of the first embodiment of the present invention as a distance between the assembly and the imaged object is 100 mm.

FIG. 2A shows an optical image lens assembly in accordance with a second embodiment of the present invention.

FIG. 2B shows the aberration curves of the second embodiment of the present invention as a distance between the assembly and an imaged object is infinite.

FIG. 2C shows the aberration curves of the second embodiment of the present invention as a distance between the assembly and the imaged object is 100 mm.

FIG. 3A shows an optical image lens assembly in accordance with a third embodiment of the present invention.

FIG. 3B shows the aberration curves of the third embodiment of the present invention as a distance between the assembly and an imaged object is infinite.

FIG. 3C shows the aberration curves of the third embodiment of the present invention as a distance between the assembly and the imaged object is 100 mm.

FIG. 4A shows an optical image lens assembly in accordance with a fourth embodiment of the present invention.

FIG. 4B shows the aberration curves of the fourth embodiment of the present invention as a distance between the assembly and an imaged object is infinite.

FIG. 4C shows the aberration curves of the fourth embodiment of the present invention as a distance between the assembly and the imaged object is 100 mm.

FIG. 5A shows an optical image lens assembly in accordance with a fifth embodiment of the present invention.

FIG. 5B shows the aberration curves of the fifth embodiment of the present invention as a distance between the assembly and an imaged object is infinite.

FIG. 5C shows the aberration curves of the fifth embodiment of the present invention as a distance between the assembly and the imaged object is 100 mm.

FIG. 6A shows an optical image lens assembly in accordance with a sixth embodiment of the present invention.

FIG. 6B shows the aberration curves of the sixth embodiment of the present invention as a distance between the assembly and an imaged object is infinite.

FIG. 6C shows the aberration curves of the sixth embodiment of the present invention as a distance between the assembly and the imaged object is 100 mm.

FIG. 7A shows an optical image lens assembly in accordance with a seventh embodiment of the present invention.

FIG. 7B shows the aberration curves of the seventh embodiment of the present invention as a distance between the assembly and an imaged object is infinite.

FIG. 7C shows the aberration curves of the seventh embodiment of the present invention as a distance between the assembly and the imaged object is 100 mm.

FIG. 8A shows an optical image lens assembly in accordance with an eighth embodiment of the present invention.

FIG. 8B shows the aberration curves of the eighth embodiment of the present invention as a distance between the assembly and an imaged object is infinite.

FIG. 8C shows the aberration curves of the eighth embodiment of the present invention as a distance between the assembly and the imaged object is 100 mm.

### DETAILED DESCRIPTION OF THE PREFERRED EMBODIMENTS

The present invention provides an optical image lens assembly comprising, in order from an object side to an image side: a first lens group comprising a first lens element with positive refractive power; a second lens group comprising a second lens element with negative refractive power; and a third lens group comprising at least three lens elements with refractive power; wherein a lens element in the third lens group closest to an image plane has negative refractive power and a concave image-side surface; wherein while a distance between an imaged object and the optical image lens assembly changes from far to near, focusing is performed by moving the second lens group along an optical axis toward the image plane; wherein there are no more than seven lens elements with refractive power in the optical image lens assembly; a focal length of the optical image lens assembly is f, a focal length of the first lens element is f1, and they satisfy the following relations as the second lens group is at the closest or the farthest position to the image plane: 0.8<f/f1<2.0.

When the relation of 0.8<f/f1<2.0 is satisfied, the refractive power of the first lens element is favorable for reducing the total track length of the assembly.

When there are no more than seven lens elements with refractive power in the optical image lens assembly, a best balance between preventing the total track length of the assembly from being too long and keeping good image quality can be achieved.

In the aforementioned optical image lens assembly, a difference of the focal lengths of the optical image lens assembly between the second lens element is at the closest and the farthest position to the image plane is ^{Δ}f, the focal length of the optical image lens assembly is f, and they preferably satisfy the following relation as the second lens group is at the closest or the farthest position to the image plane: |^{Δ}f/f|<0.1. When the above relation is satisfied, the difference of the focal length is the best for preventing the total track length from being excessively long.

In the aforementioned optical image lens assembly, preferably, at least one inflection point is formed on the image-side surface of the lens element closest to the image plane in the third lens group, and thereby the angle at which light projects onto an image sensor from the off-axis field can be effectively reduced, and the off-axis aberrations can be further corrected.

In the aforementioned optical image lens assembly, a difference of an axial distance between the first lens element and the second lens element while the second lens element is at the closest and the farthest position to the image plane is ^{Δ}T12, a lens element in the third lens group closest to the imaged object is a third lens element, an axial distance between the first lens element and the third lens element is T13, and they preferably satisfy the following relation: 0.02<|^{Δ}T12/T13|<0.4. When the above relation is satisfied, the arrangement of the first, the second and the third lens elements is more proper for assembly.

In the aforementioned optical image lens assembly, the focal length of the optical image lens assembly is f, a focal length of the third lens element is f3, and they preferably satisfy the following relation as the second lens group is at the closest or the farthest position to the image plane: −0.5<f/f3<0.5. When the above relation is satisfied, the aberration of the assembly is corrected for improving image quality by adjusting the refractive power of the third lens element; more preferably, the following relation is satisfied: −0.2<f/f3<0.2.

In the aforementioned optical image lens assembly, the focal length of the first lens element is f1, a focal length of the second lens element is f2, and they preferably satisfy the following relation: −0.7<f1/f2<−0.4. When the above relation is satisfied, the refractive power of the first and the second lens elements are more proper for obtaining wide field of view and preventing the aberration of the assembly from being too large.

In the aforementioned optical image lens assembly, a radius of curvature of the image-side surface of the lens element closest to the image plane in the third lens group is RL, the focal length of the optical image lens assembly is f, and they preferably satisfy the following relation as the second lens group is at the closest or the farthest position to the image plane: 0.1<RL/f<0.5. When the above relation is satisfied, the principal point of the assembly is favorably positioned away from the image plane, and thereby the optical total length can be reduced for keeping the assembly compact.

In the aforementioned optical image lens assembly, the assembly further comprising a stop, which can operate as an aperture stop; an axial distance between the stop and the image-side surface of the lens element closet to the image plane in the third lens group is Sd, an axial distance between an object-side surface of the first lens element and the image-side surface of the lens element closest to the image plane in the third lens group is Td, and they preferably satisfy the following relation: 0.75<Sd/Td<1.10. When the above relation is satisfied, a good balance between telecentricity and wide field of view can be achieved.

In the aforementioned optical image lens assembly, a thickness of the second lens element on the optical axis is CT2, a thickness of the third lens element on the optical axis is CT3, an axial distance between an object-side surface of the first lens element and the image-side surface of the lens element closest to the image plane in the third lens group is Td, and they preferably satisfy the following relation: 0.10<(CT2+CT3)/Td<0.22. When the above relation is satisfied, the thickness of the second and the third lens element is more proper for the assembly and space organization of the lens assembly.

In the aforementioned optical image lens assembly, a focal length of the lens element closest to the image plane in the third lens group is fL, the focal length of the first lens element is f1, and they preferably satisfy the following relation: −1.1<fL/f1<−0.4. When the above relation is satisfied, the refractive power of the first lens element and the lens element closest to the image plane in the third lens group are more balanced for reducing the occurrence of aberration.

In the aforementioned optical image lens assembly, an Abbe number of the first lens element is V1, an Abbe number of the second lens element is V2, and they preferably satisfy the following relation: 25<V1−V2<42. When the above relation is satisfied, the chromatic aberration of the first lens element can be favorably corrected.

In the aforementioned optical image lens assembly, a radius of curvature of an object-side surface of the second lens element is R3, a radius of curvature of an image-side surface of the second lens element is R4, and they preferably satisfy the following relation: 0.0<(R3+R4)/(R3−R4)<2.0. When the above relation is satisfied, the curvature of the second lens element can correct the aberration of the assembly while performing focusing.

In the aforementioned optical image lens assembly, the assembly further comprising an image sensor on the image plane; an axial distance between the object-side surface of the first lens element and the image plane is TTL, half of a diagonal length of an effective photosensitive area of the image sensor is ImgH, and they preferably satisfy the following relation: TTL/ImgH<2.2. When the above relation is satisfied, it is favorable for keeping the assembly compact for portable electronic products.

On the other hand, the present invention provides an optical image lens assembly comprising, in order from an object side to an image side: a first lens group comprising a first lens element with positive refractive power having a convex object-side surface; a second lens group comprising a second lens element with negative refractive power having a concave image-side surface; and a third lens group comprising at least three lens elements with refractive power; wherein a lens element in the third lens group closest to an image plane has negative refractive power, a concave image-side surface and at least one inflection point is form on the image-side surface thereof; wherein the third lens group also comprises a lens element with positive refractive power having a concave object-side surface and a convex image-side surface, which is adjacent to an object-side surface of the lens element closest to the image plane in the third lens group; wherein while a distance between an imaged object and the optical image lens assembly changes from far to near, focusing is performed by moving the second lens group along an optical axis toward the image plane; wherein there are no more than seven lens elements with refractive power in the optical image lens assembly; a difference of the focal lengths of the optical image lens assembly between the second lens element is at the closest and the farthest position to the image plane is ^{Δ}f, the focal length of the optical image lens assembly is f, and they satisfy the following relations as the second lens group is at the closest or the farthest position to the image plane: β^{Δ}f/f|<0.1.

When the relation of |^{Δ}f/f|<0.1 is satisfied, the difference of the focal length is the best for preventing the total track length from being excessively long.

When there are no more than seven lens elements with refractive power in the optical image lens assembly, a best balance between preventing the total track length of the assembly from being too long and keeping good image quality can be achieved; preferably, there are no more than four lens elements with refractive power in the third lens group; more preferably, there may be three lens elements with refractive power in the third lens group.

When at least one inflection point is formed on an image-side surface of the lens element closest to the image plane in the third lens group, the angle at which light projects onto the image sensor from the off-axis field can be effectively reduced, and the off-axis aberrations can be further corrected.

In the aforementioned optical image lens assembly, a difference of an axial distance between the first lens element and the second lens element while the second lens element is at the closest and the farthest position to the image plane is ^{Δ}T12, a lens element in the third lens group closest to the imaged object is a third lens element, an axial distance between the first lens element and the third lens element is T13, and they preferably satisfy the following relation: 0.02<|^{Δ}T12/T13|<0.4. When the above relation is satisfied, the arrangement of the first, the second and the third lens elements is more proper for assembly.

In the aforementioned optical image lens assembly, an Abbe number of the first lens element is V1, an Abbe number of the second lens element is V2, and they preferably satisfy the following relation: 25<V1−V2<42. When the above relation is satisfied, the chromatic aberration of the first lens element can be favorably corrected.

In the aforementioned optical image lens assembly, the focal length of the optical image lens assembly is f, a focal length of the third lens element is f3, and they preferably satisfy the following relation as the second lens group is at the closest or the farthest position to the image plane: −0.2<f/f3<0.2. When the above relation is satisfied, the aberration of the assembly is corrected for improving image quality by adjusting the refractive power of the third lens element.

In the aforementioned optical image lens assembly, a thickness of the second lens element on the optical axis is CT2, a thickness of the third lens element on the optical axis is CT3, an axial distance between an object-side surface of the first lens element and the image-side surface of the lens element closest to the image plane in the third lens group is Td, and they preferably satisfy the following relation: 0.10<(CT2+CT3)/Td<0.22. When the above relation is satisfied, the thickness of the second and the third lens element is more proper for the assembly and space organization of the lens assembly.

In the aforementioned optical image lens assembly, the assembly further comprising a stop, which can operate as an aperture stop; an axial distance between the stop and the image-side surface of the lens element closet to the image plane in the third lens group is Sd, an axial distance between an object-side surface of the first lens element and the image-side surface of the lens element closest to the image plane in the third lens group is Td, and they preferably satisfy the following relation: 0.75<Sd/Td<1.10. When the above relation is satisfied, a good balance between telecentricity and wide field of view can be achieved.

In the aforementioned optical image lens assembly, the focal length of the optical image lens assembly is f, a focal length of the first lens element is f1, and they preferably satisfy the following relation as the second lens group is at the closest or the farthest position to the image plane: 1.2<f/f1<1.6. When the above relation is satisfied, the refractive power of the first lens element is favorable for reducing the total track length of the assembly.

In the aforementioned optical image lens assembly, the lens elements can be made of glass or plastic material. If the lens elements are made of glass, the freedom for distributing the refractive power of the optical image lens assembly can be increased. If plastic material is adopted to produce the lens elements, the production cost will be reduced effectively. Additionally, the surfaces of the lens elements can be aspheric and easily made into non-spherical profiles, allowing more design parameter freedom which can be used to reduce aberrations and the number of the lens elements used in an optical system. Consequently, the total track length of the optical image lens assembly can be effectively reduced.

In the present optical image lens assembly, if a lens element is described to have a convex surface, it means the portion of the surface in proximity to the optical axis is convex; if a lens element is described to have a concave surface, it means the portion of the surface in proximity to the optical axis is concave.

In the present optical image lens assembly, there can be at least one stop, such as a glare stop or a field stop, provided for eliminating stray light and thereby promoting image resolution thereof.

It is also noted that, some factors of the optical image lens assembly, such as the focal length (f), may be varied accompanying with the movement of the second lens group during focusing. Nonetheless, those factors, such as f, may still satisfy the relations set forth in this specification.

Preferred embodiments of the present invention will be described in the following paragraphs by referring to the accompanying drawings.

### Embodiment 1

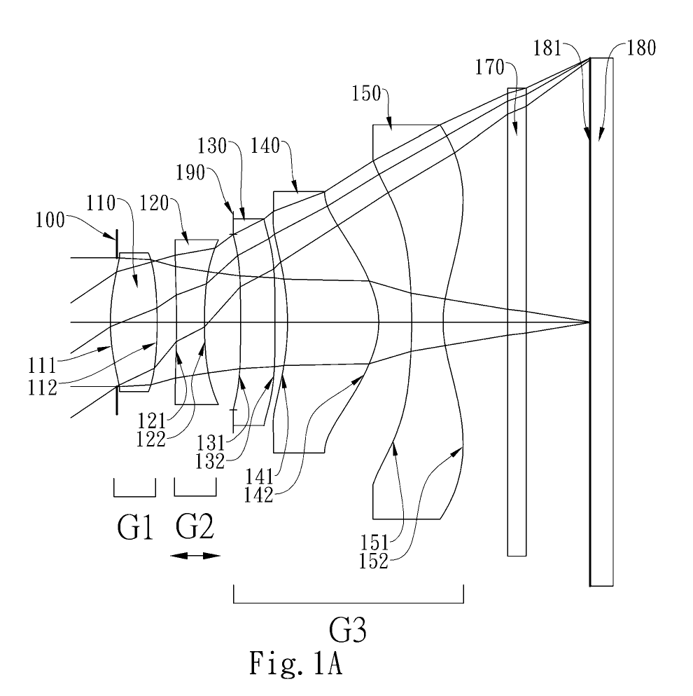

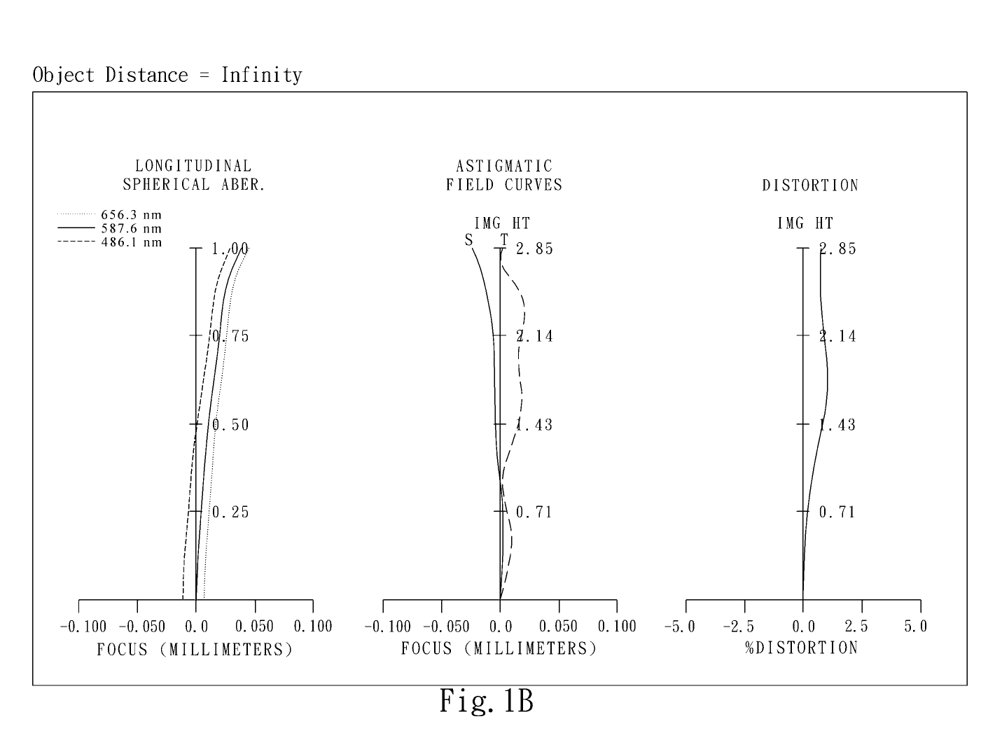

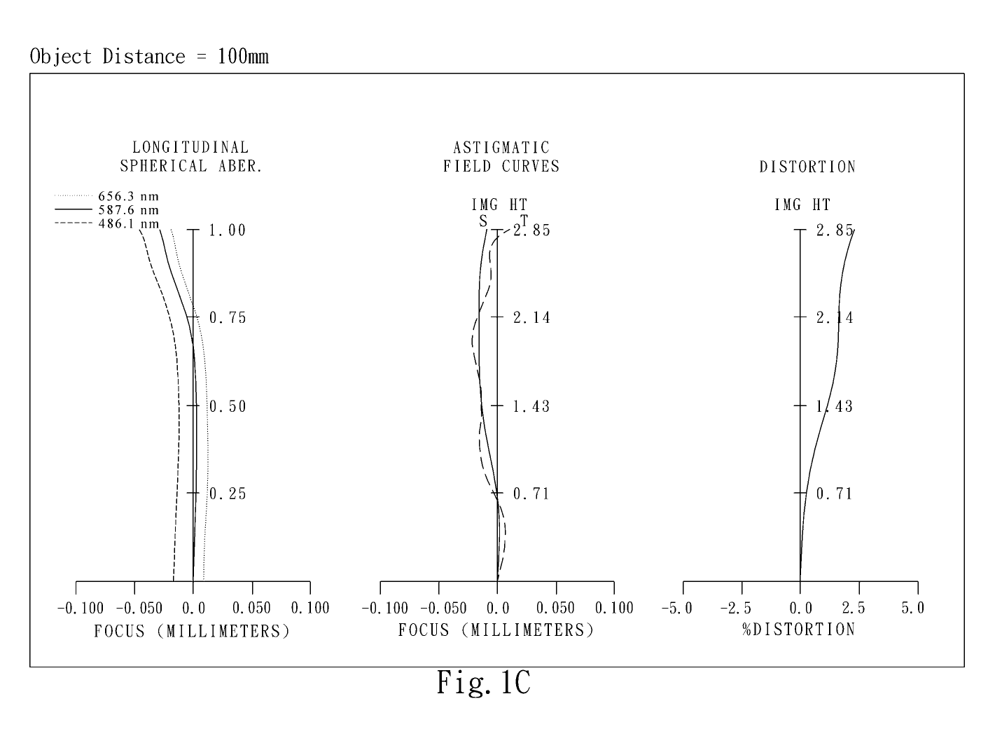

FIG. 1A shows an optical image lens assembly in accordance with the first embodiment of the present invention; meanwhile, FIG. 1B shows the aberration curves of the first embodiment as a distance between the assembly and an imaged object is infinite, and FIG. 1C shows the aberration curves as a distance between the assembly and the imaged object is 100 mm. The optical image lens assembly of the first embodiment of the present invention mainly comprises five lens elements, in order from an object side to an image side:

a first lens group G1, comprising a plastic first lens element 110 with positive refractive power having a convex object-side surface 111 and a convex image-side surface 112, the object-side and image-side surfaces 111 and 112 thereof being aspheric;

a second lens group G2, comprising a plastic second lens element 120 with negative refractive power having a concave object-side surface 121 and a concave image-side surface 122, the object-side and image-side surfaces 121 and 122 thereof being aspheric; and

a third lens group G3, comprising, in order from an object side to an image side:

a plastic third lens element 130 with positive refractive power having a convex object-side surface 131 and a convex image-side surface 132, the object-side and image-side surfaces 131 and 132 thereof being aspheric;

a plastic fourth lens element 140 with positive refractive power having a concave object-side surface 141 and a convex image-side surface 142, the object-side and image-side surfaces 141 and 142 thereof being aspheric; and

a plastic fifth lens element 150 with negative refractive power having a concave object-side surface 151 and a concave image-side surface 152, the object-side and image-side surfaces 151 and 152 thereof being aspheric, and at least one inflection point is formed on the image-side surface 152 thereof;

wherein an aperture stop 100 is disposed between an imaged object and the first lens element 110; moreover, a further stop 190 is disposed between the second lens element 120 and the third lens element 130;

the optical image lens assembly further comprises an IR filter 170 disposed between the image-side surface 152 of the fifth lens element 150 and an image plane 181, and the IR filter 170 is made of glass and has no influence on the focal length of the optical image lens assembly; the optical image lens assembly further comprises an image sensor 180 provided on the image plane 181.

In the first embodiment of the present optical image lens assembly, a lens element with negative refractive power in the third lens group closest to the image plane 181 is the fifth lens element 150; a lens element with positive refractive power, which is adjacent to the object-side surface of the lens element closest to the image plane 181 in the third lens group, is the fourth lens element 140.

The detailed optical data of the first embodiment is shown in TABLE 1, and the aspheric surface data is shown in TABLE 2, wherein the units of the radius of curvature, the thickness and the focal length are expressed in mm, and HFOV is half of the maximal field of view.

TABLE 1
(Embodiment 1)
Object Distance = Infinity: f = 4.18 mm, Fno = 3.00, HFOV = 34.0 deg.

| | | | | | | | | Focal |
|---|---|---|---|---|---|---|---|---|
| Surface # | | Curvature Radius | | Thickness | Material | Index | Abbe # | length |
| 0 | Object | Plano | | Infinity, 100 | | | | |
| 1 | Ape. Stop | Plano | | −0.070 | | | | |
| 2 | Lens 1 | 2.076477 | (ASP) | 0.507 | Plastic | 1.544 | 55.9 | 2.77 |
| 3 | | −5.042191 | (ASP) | 0.212, 0.296 | | | | |
| 4 | Lens 2 | −7.904896 | (ASP) | 0.302 | Plastic | 1.634 | 23.8 | −4.59 |
| 5 | | 4.668647 | (ASP) | 0.391, 0.307 | | | | |
| 6 | Lens 3 | 73.380170 | (ASP) | 0.373 | Plastic | 1.634 | 23.8 | 89.35 |
| 7 | | −247.919774 | (ASP) | 0.138 | | | | |
| 8 | Lens 4 | −2.648192 | (ASP) | 0.990 | Plastic | 1.544 | 55.9 | 2.06 |
| 9 | | −0.890074 | (ASP) | 0.357 | | | | |
| 10 | Lens 5 | −6.196960 | (ASP) | 0.340 | Plastic | 1.530 | 55.8 | −1.93 |
| 11 | | 1.246152 | (ASP) | 0.700 | | | | |

| | | | | | | | |
|---|---|---|---|---|---|---|---|
| 12 | IR-filter | Plano | 0.200 | Glass | 1.517 | 64.2 | — |
| 13 | | Plano | 0.695 | | | | |
| 14 | Image | Plano | — | | | | |

* Reference wavelength is 587.6 nm (d-line)
* Effective radius of surface 6(Stop) is 0.95 mm
* Object Distance = 100 mm: surface 3 thickness = 0.296 mm, surface 5 thickness = 0.307 mm, f = 4.07 mm

TABLE 2
Aspheric Coefficients

| | Surface # | | | | |
|---|---|---|---|---|---|
| | 2 | 3 | 4 | 5 | 6 |
| k = | −1.51242E+01 | −1.19249E+01 | −9.00000E+01 | 1.59362E+01 | 9.00000E+01 |
| A4 = | 1.48076E−01 | −7.96870E−02 | 7.67948E−02 | 9.49649E−02 | −1.11149E−01 |
| A6 = | −2.80201E−01 | −4.57985E−03 | −8.58111E−02 | −2.24753E−02 | −1.40568E−01 |
| A8 = | 1.64831E−01 | −2.79419E−01 | 2.69811E−01 | 9.66704E−02 | 4.00312E−01 |
| A10 = | −1.78763E−01 | 3.94183E−01 | −9.01886E−01 | −3.37645E−01 | −4.27394E−01 |
| A12 = | 1.37696E−01 | −3.05257E−01 | 1.29981E+00 | 4.06998E−01 | 1.85441E−01 |
| A14 = | −2.45826E−01 | 9.59366E−03 | −6.62044E−01 | −1.77503E−01 | |
| | Surface # | | | | |
| | 7 | 8 | 9 | 10 | 11 |
| k = | −9.00000E+01 | 2.72614E+00 | −3.34113E+00 | −9.00000E+01 | −8.17739E+00 |
| A4 = | −6.59473E−02 | 5.55044E−02 | −1.10341E−01 | −2.28918E−02 | −5.97437E−02 |
| A6 = | −1.10812E−01 | 5.72050E−02 | 1.32398E−01 | −2.97003E−02 | 1.58793E−02 |
| A8 = | 1.33165E−01 | −2.11013E−01 | −1.13214E−01 | 1.23461E−02 | −5.60837E−03 |
| A10 = | −6.17833E−02 | 3.09737E−01 | 6.72999E−02 | −7.46568E−04 | 1.47183E−03 |
| A12 = | 1.81434E−02 | −1.69769E−01 | −1.75002E−02 | −2.00559E−04 | −2.18973E−04 |
| A14 = | | 3.35796E−02 | 1.48331E−03 | 2.35992E−05 | 1.34628E−05 |

The equation of the aspheric surface profiles is expressed as follows:

$$X ( Y ) = ( {Y}^{2} \text{/} R ) \text{/} ( 1 + sqrt ( 1 - ( 1 + k ) * {( Y \text{/} R )}^{2} ) ) + {\sum }_{i} ( Ai ) * ( {Y}^{i} )$$

wherein:

X: the height of a point on the aspheric surface at a distance Y from the optical axis relative to the tangential plane at the aspheric surface vertex;

Y: the distance from the point on the curve of the aspheric surface to the optical axis;

k: the conic coefficient;

Ai: the aspheric coefficient of order i.

In the first embodiment of the present optical image lens assembly, the focal length of the optical image lens assembly is f, and it satisfies the following relation as the distance between the assembly and the imaged object is infinity mm: f=4.18 (mm); as the distance between the assembly and the imaged object is 100 mm: f=4.07 (mm).

In the first embodiment of the present optical image lens assembly, the f-number of the optical image lens assembly is Fno, and it satisfies the relation: Fno=3.00.

In the first embodiment of the present optical image lens assembly, half of the maximal field of view of the optical image lens assembly is HFOV, and it satisfies the relation: HFOV=34.0 deg.

In the first embodiment of the present optical image lens assembly, an Abbe number of the first lens element 110 is V1, an Abbe number of the second lens element 120 is V2, and they satisfy the relation: V1−V2=32.1.

In the first embodiment of the present optical image lens assembly, a thickness of the second lens element 120 on the optical axis is CT2, a thickness of the third lens element 130 on the optical axis is CT3, an axial distance between an object-side surface 111 of the first lens element 110 and the image-side surface 152 of the fifth lens element 150 is Td, and they satisfy the relation: (CT2+CT3)/Td=0.19.

In the first embodiment of the present optical image lens assembly, a difference of an axial distance between the first lens element 110 and the second lens element 120 while the second lens element 120 is at the closest and the farthest position to the image plane 181 is ^{Δ}T12, an axial distance between the first lens element 110 and the third lens element 130 is T13, and they satisfy the following relation: |^{Δ}T12/T13|=0.09.

In the first embodiment of the present optical image lens assembly, a radius of curvature of the object-side surface 121 of the second lens element 120 is R3, a radius of curvature of an image-side surface 122 of the second lens element 120 is R4, and they satisfy the following relation: (R3+R4)/(R3−R4)=0.26

In the first embodiment of the present optical image lens assembly, a radius of curvature of the image-side surface 152 of the fifth lens element 150 is RL, the focal length of the optical image lens assembly is f, and they satisfy the following relation as the second lens element 120 is at the farthest position to the image plane 181: RL/f=0.30.

In the first embodiment of the present optical image lens assembly, the focal length of the first lens element 110 is f1, a focal length of the second lens element 120 is f2, and they satisfy the following relation: f1/f2=−0.60.

In the first embodiment of the present optical image lens assembly, the focal length of the optical image lens assembly is f, the focal length of the first lens element 110 is f1, and they satisfy the following relation as the second lens element 120 is at the farthest position to the image plane 181: f/f1=1.51.

In the first embodiment of the present optical image lens assembly, the focal length of the optical image lens assembly is f, the focal length of the third lens element 130 is f3, and they satisfy the following relation as the second lens element 120 is at the farthest position to the image plane 181: f/f3=0.05.

In the first embodiment of the present optical image lens assembly, the focal length of the fifth lens element 150 is fL, the focal length of the first lens element 110 is f1, and they satisfy the following relation: fL/f1=−0.70.

In the first embodiment of the present optical image lens assembly, a difference of the focal lengths of the optical image lens assembly between the second lens element 120 is at the closest and the farthest position to the image plane is 181 ^{Δ}f, the focal length of the optical image lens assembly is f, and they satisfy the following relation as the second lens element 120 is at the farthest position to the image plane 181: β^{Δ}f/f|=0.03.

In the first embodiment of the present optical image lens assembly, an axial distance between the aperture stop 100 and the image-side surface 152 of the fifth lens element 150 is Sd, an axial distance between an object-side surface 111 of the first lens element 110 and the image-side surface 152 of the fifth lens element 150 is Td, and they satisfy the following relation: Sd/Td=0.98.

In the first embodiment of the present optical image lens assembly, the axial distance between the object-side surface 111 of the first lens element 110 and the image plane 181 is TTL, half of the diagonal length of the effective photosensitive area of the image sensor 180 is ImgH, and they satisfy the following relation as the first lens element 110 is at the closest position to the image plane 181: TTL/ImgH=1.80.

### Embodiment 2

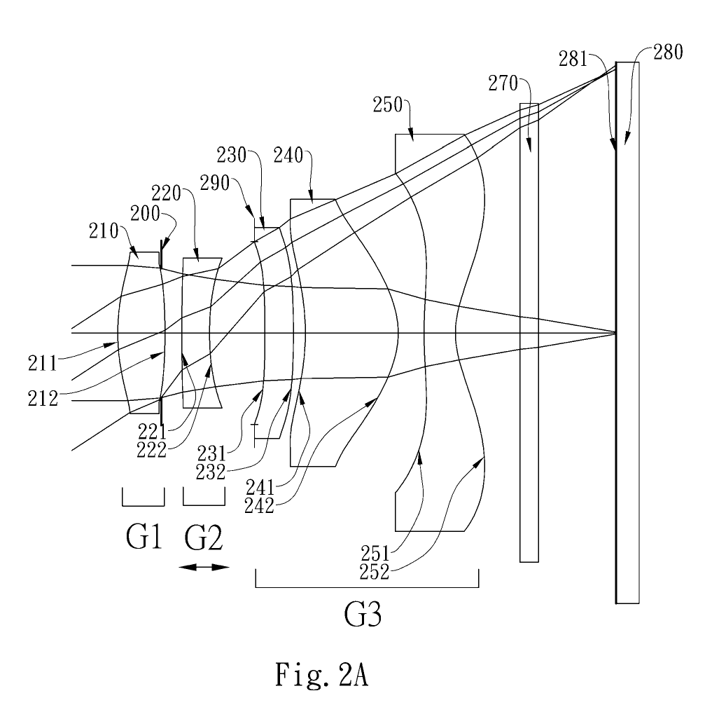

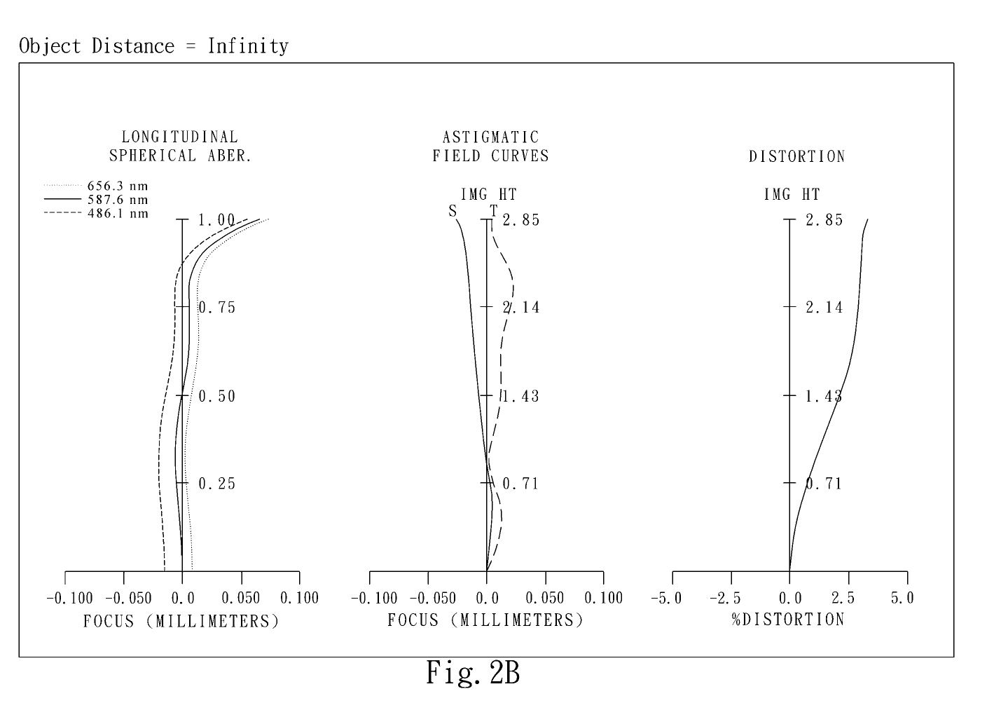

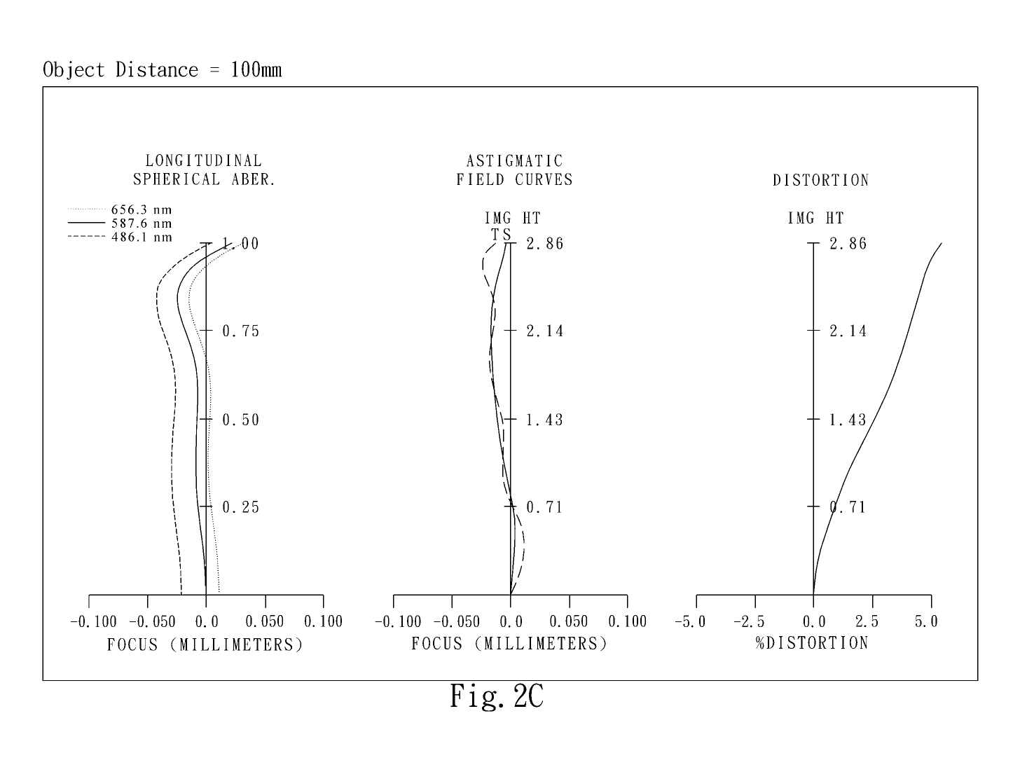

FIG. 2A shows an optical image lens assembly in accordance with the second embodiment of the present invention; meanwhile, FIG. 2B shows the aberration curves of the second embodiment as a distance between the assembly and an imaged object is infinite, and FIG. 2C shows the aberration curves as a distance between the assembly and the imaged object is 100 mm. The optical image lens assembly of the second embodiment of the present invention mainly comprises five lens elements, in order from an object side to an image side:

a first lens group G1, comprising a plastic first lens element 210 with positive refractive power having a convex object-side surface 211 and a convex image-side surface 212, the object-side and image-side surfaces 211 and 212 thereof being aspheric;

a second lens group G2, comprising a plastic second lens element 220 with negative refractive power having a convex object-side surface 221 and a concave image-side surface 222, the object-side and image-side surfaces 221 and 222 thereof being aspheric; and

a third lens group G3, comprising, in order from an object side to an image side:

a plastic third lens element 230 with positive refractive power having a concave object-side surface 231 and a convex image-side surface 232, the object-side and image-side surfaces 231 and 232 thereof being aspheric;

a plastic fourth lens element 240 with positive refractive power having a concave object-side surface 241 and a convex image-side surface 242, the object-side and image-side surfaces 241 and 242 thereof being aspheric; and

a plastic fifth lens element 250 with negative refractive power having a convex object-side surface 251 and a concave image-side surface 252, the object-side and image-side surfaces 251 and 252 thereof being aspheric, and at least one inflection point is formed on both the object-side surface 251 and the image-side surface 252 thereof;

wherein an aperture stop 200 is disposed between the first lens element 210 and the second lens element 220; moreover, a further stop 290 is disposed between the second lens element 220 and the third lens element 230;

the optical image lens assembly further comprises an IR filter 270 disposed between the image-side surface 252 of the fifth lens element 250 and an image plane 281, and the IR filter 270 is made of glass and has no influence on the focal length of the optical image lens assembly; the optical image lens assembly further comprises an image sensor 280 provided on the image plane 281.

In the second embodiment of the present optical image lens assembly, a lens element with negative refractive power in the third lens group closest to the image plane 281 is the fifth lens element 250; a lens element with positive refractive power, which is adjacent to the object-side surface of the lens element closest to the image plane 281 in the third lens group, is the fourth lens element 240.

The detailed optical data of the second embodiment is shown in TABLE 3, and the aspheric surface data is shown in TABLE 4, wherein the units of the radius of curvature, the thickness and the focal length are expressed in mm, and HFOV is half of the maximal field of view.

TABLE 3
(Embodiment 2)
Object Distance = Infinity: f = 4.24 mm, Fno = 2.90, HFOV = 33.1 deg.

| | | | | | | | | Focal |
|---|---|---|---|---|---|---|---|---|
| Surface # | | Curvature Radius | | Thickness | Material | Index | Abbe # | length |
| 0 | Object | Plano | | Infinity, 100 | | | | |
| 1 | Lens 1 | 2.166392 | (ASP) | 0.512 | Plastic | 1.544 | 55.9 | 3.05 |
| 2 | | −6.544999 | (ASP) | −0.040 | | | | |
| 3 | Ape. Stop | Plano | | 0.223, 0.337 | | | | |
| 4 | Lens 2 | 55.308473 | (ASP) | 0.300 | Plastic | 1.633 | 23.4 | −5.03 |
| 5 | | 3.000999 | (ASP) | 0.600, 0.486 | | | | |
| 6 | Lens 3 | −17.830771 | (ASP) | 0.310 | Plastic | 1.634 | 23.8 | 26.86 |
| 7 | | −8.769573 | (ASP) | 0.130 | | | | |
| 8 | Lens 4 | −2.429687 | (ASP) | 1.006 | Plastic | 1.544 | 55.9 | 2.24 |
| 9 | | −0.930111 | (ASP) | 0.281 | | | | |
| 10 | Lens 5 | 5.190544 | (ASP) | 0.340 | Plastic | 1.530 | 55.8 | −2.25 |
| 11 | | 0.946229 | (ASP) | 0.700 | | | | |

| | | | | | | | |
|---|---|---|---|---|---|---|---|
| 12 | IR-filter | Plano | 0.200 | Glass | 1.517 | 64.2 | — |
| 13 | | Plano | 0.842 | | | | |
| 14 | Image | Plano | — | | | | |

* Reference wavelength is 587.6 nm (d-line)
* Effective radius of surface 6(Stop) is 0.99 mm
* Object Distance = 100 mm: surface 3 thickness = 0.337 mm, surface 5 thickness = 0.486 mm, f = 4.14 mm

TABLE 4
Aspheric Coefficients

| | Surface # | | | | |
|---|---|---|---|---|---|
| | 1 | 2 | 4 | 5 | 6 |
| k = | −1.33895E+01 | −3.94388E+01 | −9.00000E+01 | 8.90871E+00 | −5.02377E+01 |
| A4 = | 1.32016E−01 | −5.60017E−02 | 4.79899E−02 | 2.44863E−02 | −4.06819E−02 |
| A6 = | −2.31151E−01 | 1.51584E−02 | −6.93873E−02 | −4.89339E−02 | −1.95824E−01 |
| A8 = | 2.46545E−01 | −2.05656E−01 | 2.50602E−01 | 8.32222E−02 | 3.62053E−01 |
| A10 = | −2.34226E−01 | 2.42562E−01 | −7.88241E−01 | −3.18107E−01 | −3.78118E−01 |
| A12 = | −1.63081E−03 | −8.10537E−02 | 1.18149E+00 | 4.30628E−01 | 1.63701E−01 |
| A14 = | 5.67629E−02 | −5.40056E−02 | −6.96397E−01 | −2.75695E−01 | |
| | Surface # | | | | |
| | 7 | 8 | 9 | 10 | 11 |
| k = | −9.00000E+01 | 2.22275E+00 | −3.83254E+00 | −1.00000E+00 | −4.85566E+00 |
| A4 = | −1.92315E−03 | 9.37067E−02 | −1.22656E−01 | −9.39767E−02 | −8.12035E−02 |
| A6 = | −1.37251E−01 | 4.96007E−02 | 1.25707E−01 | −3.68236E−03 | 2.54595E−02 |
| A8 = | 1.24409E−01 | −2.19052E−01 | −1.15221E−01 | 1.02452E−02 | −7.03169E−03 |
| A10 = | −6.53730E−02 | 3.07487E−01 | 6.76786E−02 | −1.72363E−03 | 1.43274E−03 |
| A12 = | 2.04537E−02 | −1.69419E−01 | −1.72889E−02 | −3.04912E−04 | −1.95771E−04 |
| A14 = | | 3.47375E−02 | 1.37325E−03 | 7.11846E−05 | 1.18331E−05 |

The equation of the aspheric surface profiles of the second embodiment has the same form as that of the first embodiment. Moreover, the description of the factors in the relations is as those set forth in the first embodiment, but the values of the relations of the second embodiment are listed in the following TABLE 5.

TABLE 5
(Embodiment 2)

| | | | |
|---|---|---|---|
| f | 4.24 | f1/f2 | −0.61 |
| Fno | 2.90 | f/f1 | 1.39 |
| HFOV | 33.1 | f/f3 | 0.16 |
| V1 − V2 | 32.5 | fL/f1 | −0.74 |
| (CT2 + CT3)/Td | 0.17 | \|Δf/f\| | 0.02 |
| \|ΔT12/T13\| | 0.10 | SD/TD | 0.87 |
| (R3 + R4)/(R3 − R4) | 1.11 | TTL/ImgH | 1.87 |
| RL/f | 0.22 | | |

### Embodiment 3

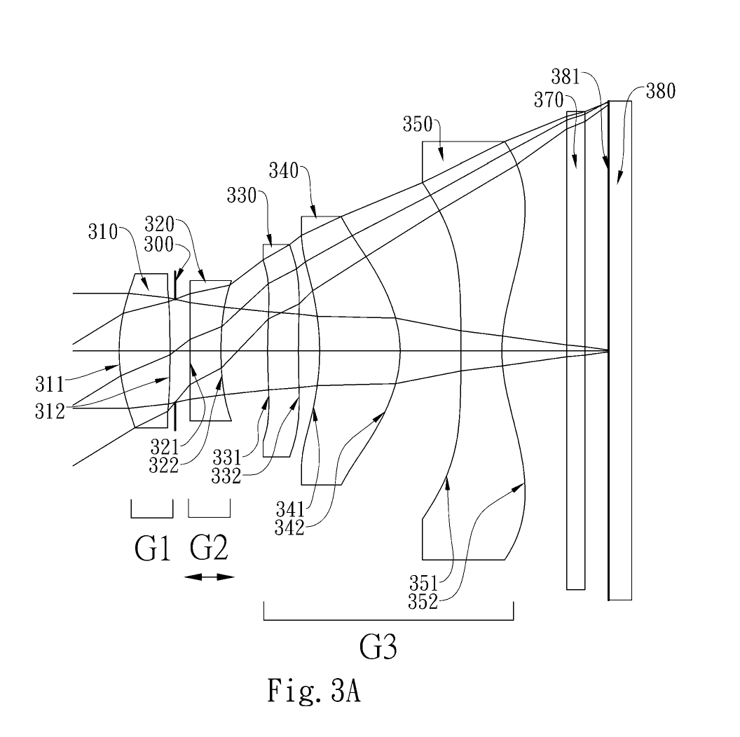

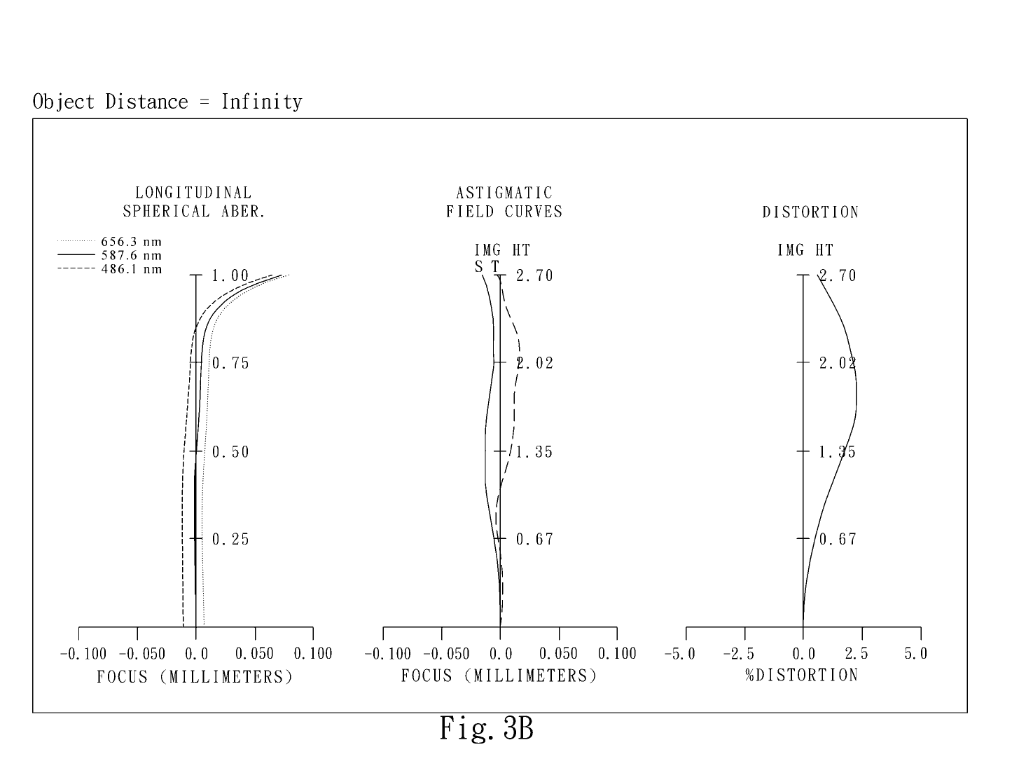

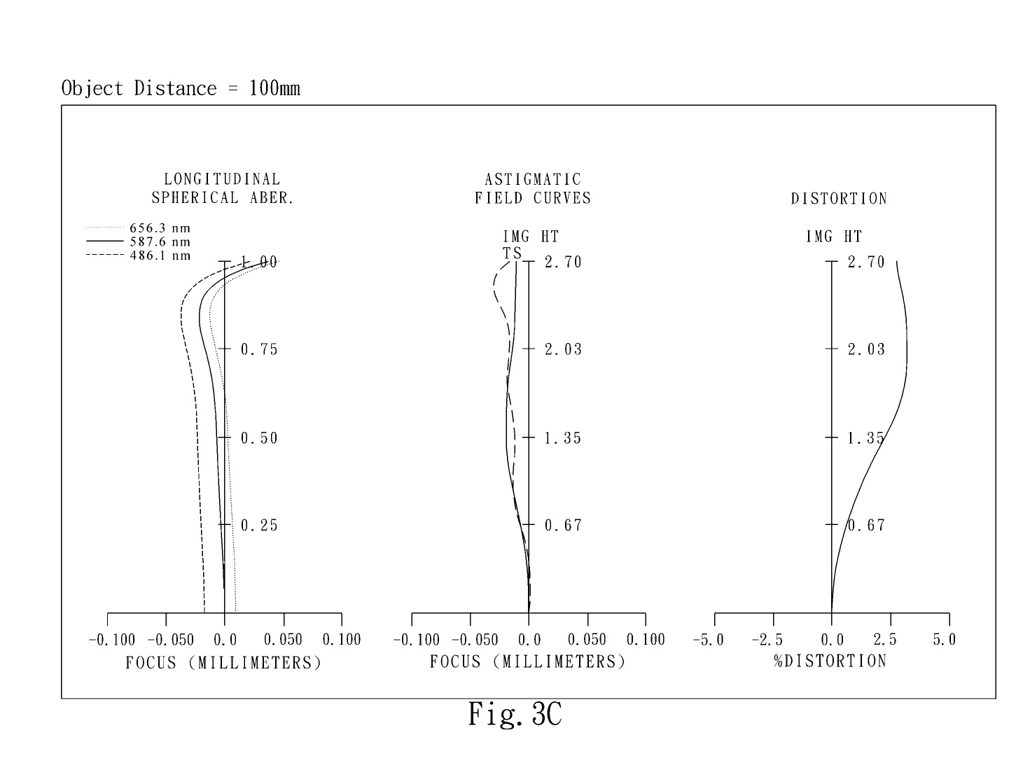

FIG. 3A shows an optical image lens assembly in accordance with the third embodiment of the present invention; meanwhile, FIG. 3B shows the aberration curves of the third embodiment as a distance between the assembly and an imaged object is infinite, and FIG. 3C shows the aberration curves as a distance between the assembly and the imaged object is 100 mm. The optical image lens assembly of the third embodiment of the present invention mainly comprises five lens elements, in order from an object side to an image side:

a first lens group G1, comprising a plastic first lens element 310 with positive refractive power having a convex object-side surface 311 and a convex image-side surface 312, the object-side and image-side surfaces 311 and 312 thereof being aspheric;

a second lens group G2, comprising a plastic second lens element 320 with negative refractive power having a concave object-side surface 321 and a concave image-side surface 322, the object-side and image-side surfaces 321 and 322 thereof being aspheric; and

a third lens group G3, comprising, in order from an object side to an image side:

a plastic third lens element 330 with positive refractive power having a convex object-side surface 331 and a concave image-side surface 332, the object-side and image-side surfaces 331 and 332 thereof being aspheric;

a plastic fourth lens element 340 with positive refractive power having a concave object-side surface 341 and a convex image-side surface 342, the object-side and image-side surfaces 341 and 342 thereof being aspheric; and

a plastic fifth lens element 350 with negative refractive power having a concave object-side surface 351 and a concave image-side surface 352, the object-side and image-side surfaces 351 and 352 thereof being aspheric, and at least one inflection point is formed on the image-side surface 352 thereof;

wherein an aperture stop 300 is disposed between the first lens element 310 and the second lens element 320;

the optical image lens assembly further comprises an IR filter 370 disposed between the image-side surface 352 of the fifth lens element 350 and an image plane 381, and the IR filter 370 is made of glass and has no influence on the focal length of the optical image lens assembly; the optical image lens assembly further comprises an image sensor 380 provided on the image plane 381.

In the third embodiment of the present optical image lens assembly, a lens element with negative refractive power in the third lens group closest to the image plane 381 is the fifth lens element 350; a lens element with positive refractive power, which is adjacent to the object-side surface of the lens element closest to the image plane 381 in the third lens group, is the fourth lens element 340.

The detailed optical data of the third embodiment is shown in TABLE 6, and the aspheric surface data is shown in TABLE 7, wherein the units of the radius of curvature, the thickness and the focal length are expressed in mm, and HFOV is half of the maximal field of view.

TABLE 6
(Embodiment 3)
Object Distance = Infinity: f = 4.36 mm, Fno = 3.50, HFOV = 31.6 deg.

| | | | | | | | | Focal |
|---|---|---|---|---|---|---|---|---|
| Surface # | | Curvature Radius | | Thickness | Material | Index | Abbe # | length |
| 0 | Object | Plano | | Infinity, 100 | | | | |
| 1 | Lens 1 | 1.851616 | (ASP) | 0.551 | Plastic | 1.544 | 55.9 | 3.03 |
| 2 | | −13.526273 | (ASP) | 0.055 | | | | |
| 3 | Ape. Stop | Plano | | 0.163, 0.275 | | | | |
| 4 | Lens 2 | −25.501684 | (ASP) | 0.333 | Plastic | 1.633 | 23.4 | −4.65 |
| 5 | | 3.343621 | (ASP) | 0.506, 0.394 | | | | |
| 6 | Lens 3 | 6.065684 | (ASP) | 0.334 | Plastic | 1.583 | 30.2 | 26.60 |
| 7 | | 9.755421 | (ASP) | 0.230 | | | | |
| 8 | Lens 4 | −2.667225 | (ASP) | 0.873 | Plastic | 1.543 | 56.5 | 3.56 |
| 9 | | −1.250000 | (ASP) | 0.659 | | | | |
| 10 | Lens 5 | −41.052599 | (ASP) | 0.445 | Plastic | 1.535 | 56.3 | −3.14 |
| 11 | | 1.758007 | (ASP) | 0.700 | | | | |

| | | | | | | | |
|---|---|---|---|---|---|---|---|
| 12 | IR-filter | Plano | 0.200 | Glass | 1.517 | 64.2 | — |
| 13 | | Plano | 0.255 | | | | |
| 14 | Image | Plano | — | | | | |

* Reference wavelength is 587.6 nm (d-line)
* Object Distance = 100 mm: surface 3 thickness = 0.275 mm, surface 5 thickness = 0.394 mm, f = 4.21 mm

TABLE 7
Aspheric Coefficients

| | Surface # | | | | |
|---|---|---|---|---|---|
| | 1 | 2 | 4 | 5 | 6 |
| k = | −1.00869E+01 | 6.98758E+01 | 8.30465E+01 | 8.47642E+00 | 1.67905E+01 |
| A4 = | 1.74730E−01 | −2.59217E−02 | 6.46114E−02 | 5.27669E−02 | −1.02742E−01 |
| A6 = | −2.25986E−01 | 2.60354E−02 | −7.17426E−02 | −1.45262E−02 | −1.69659E−01 |
| A8 = | 2.19354E−01 | −3.12951E−01 | 2.74714E−01 | 7.22203E−02 | 3.54676E−01 |
| A10 = | −2.06332E−01 | 4.04613E−01 | −1.01631E+00 | −3.36810E−01 | −4.18094E−01 |
| A12 = | 3.85638E−02 | −8.80722E−03 | 1.36588E+00 | 4.84940E−01 | 1.85696E−01 |
| A14 = | 2.88902E−02 | 1.51988E−02 | −6.90331E−01 | −2.94963E−01 | |
| | Surface # | | | | |
| | 7 | 8 | 9 | 10 | 11 |
| k = | 3.78184E+01 | 2.74128E+00 | −3.94694E+00 | −4.47865E+01 | −4.90930E+00 |
| A4 = | −6.10110E−02 | 4.65184E−02 | −1.18929E−01 | −2.28373E−02 | −5.50344E−02 |
| A6 = | −1.22905E−01 | 5.44888E−02 | 1.24064E−01 | −2.47201E−02 | 1.66423E−02 |
| A8 = | 1.26038E−01 | −2.13675E−01 | −1.15326E−01 | 1.09587E−02 | −6.04549E−03 |
| A10 = | −6.71296E−02 | 3.08714E−01 | 6.70678E−02 | −1.11579E−03 | 1.49740E−03 |
| A12 = | 1.90308E−02 | −1.69923E−01 | −1.74816E−02 | −2.22213E−04 | −2.07686E−04 |
| A14 = | | 3.36546E−02 | 1.45692E−03 | 4.40475E−05 | 1.17838E−05 |

The equation of the aspheric surface profiles of the third embodiment has the same form as that of the first embodiment. Moreover, the description of the factors in the relations is as those set forth in the first embodiment, but the values of the relations of the third embodiment are listed in the following TABLE 8.

TABLE 8
(Embodiment 3)

| | | | |
|---|---|---|---|
| f | 4.36 | f1/f2 | −0.65 |
| Fno | 3.50 | f/f1 | 1.44 |
| HFOV | 31.6 | f/f3 | 0.16 |
| V1 − V2 | 32.5 | fL/f1 | −1.04 |
| (CT2 + CT3)/Td | 0.16 | \|Δf/f\| | 0.03 |
| \|ΔT12/T13\| | 0.11 | SD/TD | 0.85 |
| (R3 + R4)/(R3 − R4) | 0.77 | TTL/ImgH | 1.94 |
| RL/f | 0.40 | | |

### Embodiment 4

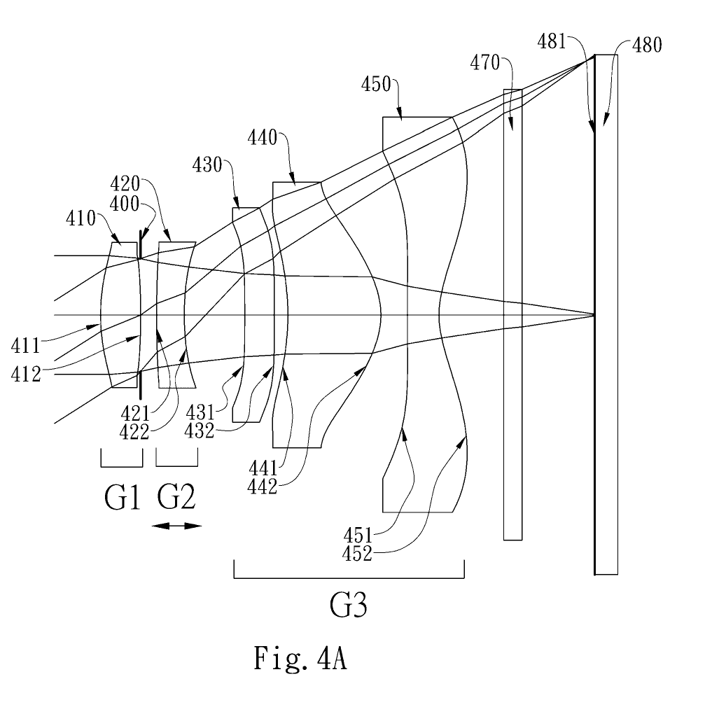

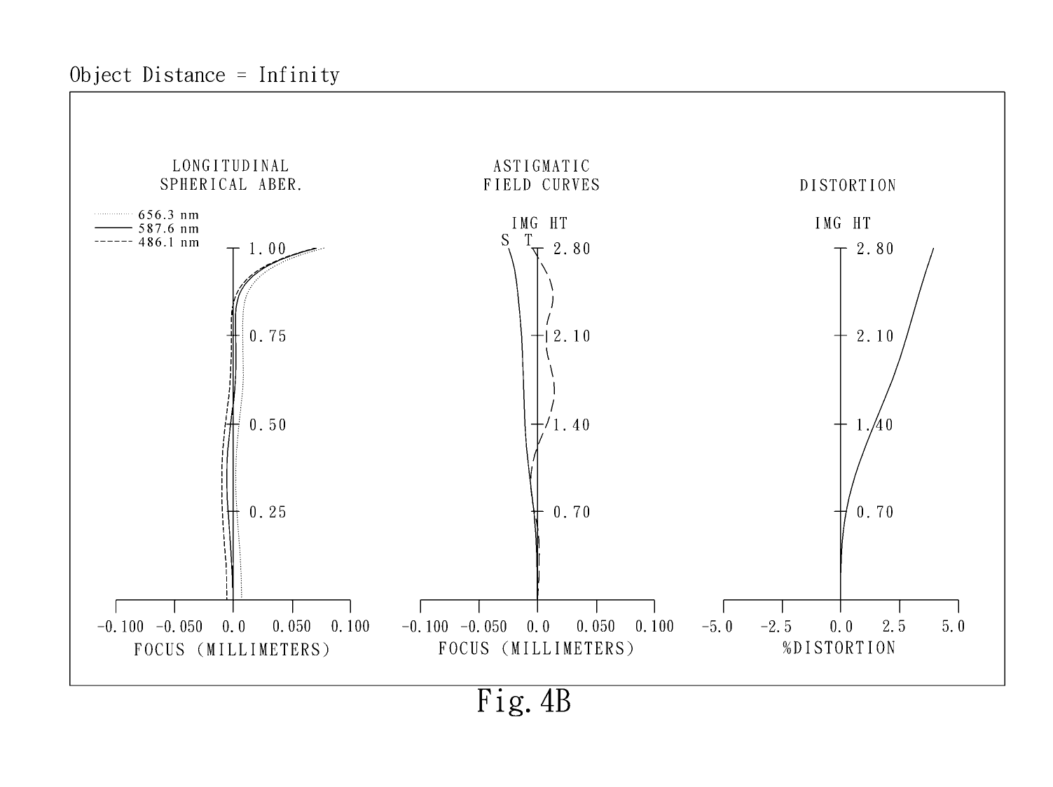

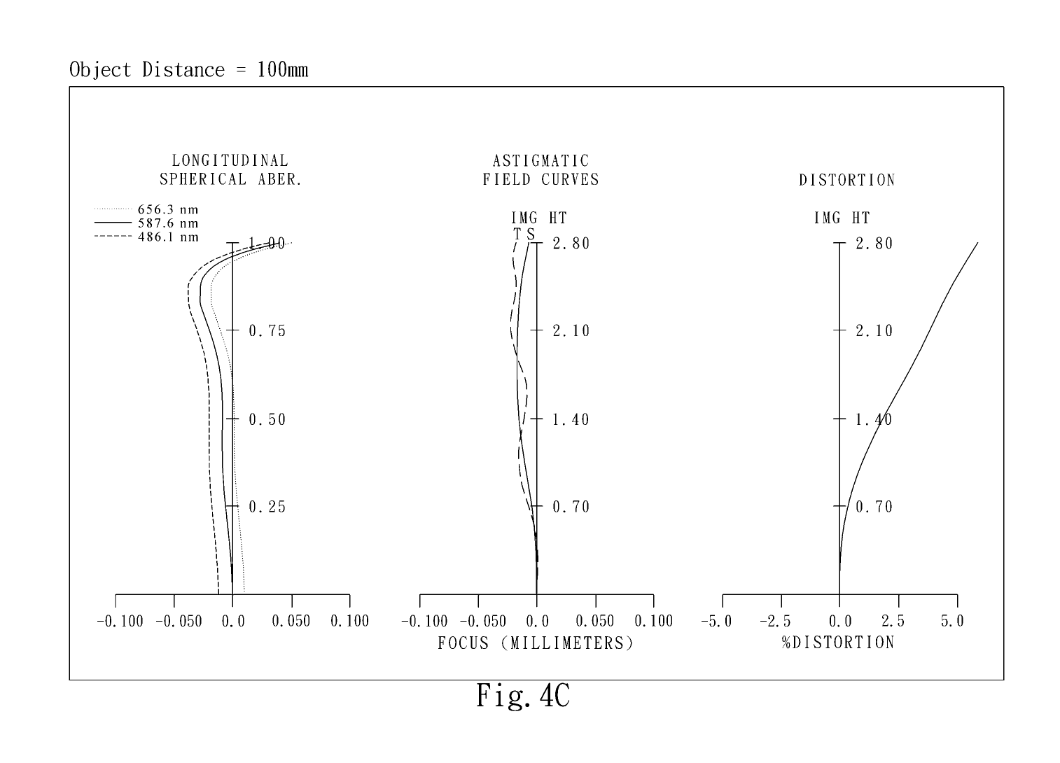

FIG. 4A shows an optical image lens assembly in accordance with the four embodiment of the present invention; meanwhile, FIG. 4B shows the aberration curves of the four embodiment as a distance between the assembly and an imaged object is infinite, and FIG. 4C shows the aberration curves as a distance between the assembly and the imaged object is 100 mm. The optical image lens assembly of the four embodiment of the present invention mainly comprises five lens elements, in order from an object side to an image side:

a first lens group G1, comprising a plastic first lens element 410 with positive refractive power having a convex object-side surface 411 and a convex image-side surface 412, the object-side and image-side surfaces 411 and 412 thereof being aspheric;

a second lens group G2, comprising a plastic second lens element 420 with negative refractive power having a convex object-side surface 421 and a concave image-side surface 422, the object-side and image-side surfaces 421 and 422 thereof being aspheric; and

a third lens group G3, comprising, in order from an object side to an image side:

a plastic third lens element 430 with negative refractive power having a concave object-side surface 431 and a concave image-side surface 432, the object-side and image-side surfaces 431 and 432 thereof being aspheric;

a plastic fourth lens element 440 with positive refractive power having a concave object-side surface 441 and a convex image-side surface 442, the object-side and image-side surfaces 441 and 442 thereof being aspheric; and

a plastic fifth lens element 450 with negative refractive power having a convex object-side surface 451 and a concave image-side surface 452, the object-side and image-side surfaces 451 and 452 thereof being aspheric, and at least one inflection point is formed on both the object-side surface 451 and the image-side surface 452 thereof;

wherein an aperture stop 400 is disposed between the first lens element 410 and the second lens element 420;

the optical image lens assembly further comprises an IR filter 470 disposed between the image-side surface 452 of the fifth lens element 450 and an image plane 481, and the IR filter 470 is made of glass and has no influence on the focal length of the optical image lens assembly; the optical image lens assembly further comprises an image sensor 480 provided on the image plane 481.

In the fourth embodiment of the present optical image lens assembly, a lens element with negative refractive power in the third lens group closest to the image plane 481 is the fifth lens element 450; a lens element with positive refractive power, which is adjacent to the object-side surface of the lens element closest to the image plane 481 in the third lens group, is the fourth lens element 440.

The detailed optical data of the fourth embodiment is shown in TABLE 9, and the aspheric surface data is shown in TABLE 10, wherein the units of the radius of curvature, the thickness and the focal length are expressed in mm, and HFOV is half of the maximal field of view.

TABLE 9
(Embodiment 4)
Object Distance = Infinity: f = 4.25 mm, Fno = 3.30, HFOV = 32.3 deg.

| | | | | | | | | Focal |
|---|---|---|---|---|---|---|---|---|
| Surface # | | Curvature Radius | | Thickness | Material | Index | Abbe # | length |
| 0 | Object | Plano | | Infinity, 100 | | | | |
| 1 | Lens 1 | 2.059948 | (ASP) | 0.435 | Plastic | 1.535 | 56.3 | 3.15 |
| 2 | | −8.547417 | (ASP) | 0.000 | | | | |
| 3 | Ape. Stop | Plano | | 0.173, 0.307 | | | | |
| 4 | Lens 2 | 15.168972 | (ASP) | 0.300 | Plastic | 1.650 | 21.4 | −5.76 |
| 5 | | 2.976451 | (ASP) | 0.655, 0.521 | | | | |
| 6 | Lens 3 | −270.811245 | (ASP) | 0.318 | Plastic | 1.607 | 26.6 | −49.88 |
| 7 | | 34.121226 | (ASP) | 0.150 | | | | |
| 8 | Lens 4 | −2.771439 | (ASP) | 1.010 | Plastic | 1.544 | 55.9 | 1.88 |
| 9 | | −0.841477 | (ASP) | 0.287 | | | | |
| 10 | Lens 5 | 29.537912 | (ASP) | 0.344 | Plastic | 1.535 | 56.3 | −1.93 |
| 11 | | 0.991524 | (ASP) | 0.700 | | | | |

| | | | | | | | |
|---|---|---|---|---|---|---|---|
| 12 | IR-filter | Plano | 0.200 | Glass | 1.517 | 64.2 | — |
| 13 | | Plano | 0.788 | | | | |
| 14 | Image | Plano | — | | | | |

* Reference wavelength is 587.6 nm (d-line)
* Object Distance = 100 mm: surface 3 thickness = 0.307 mm, surface 5 thickness = 0.521 mm, f = 4.14 mm

TABLE 10
Aspheric Coefficients

| | Surface # | | | | |
|---|---|---|---|---|---|
| | 1 | 2 | 4 | 5 | 6 |
| k = | −1.18730E+01 | −5.35576E+01 | −7.00000E+01 | 3.77026E+00 | 7.00000E+01 |
| A4 = | 1.37903E−01 | −5.03333E−02 | 3.80196E−02 | 3.22468E−02 | −1.08805E−01 |
| A6 = | −2.48336E−01 | −8.07059E−03 | −5.24299E−02 | −7.69092E−03 | −1.58390E−01 |
| A8 = | 2.86537E−01 | −1.91211E−01 | 2.67417E−01 | 9.95710E−02 | 3.70497E−01 |
| A10 = | −2.88452E−01 | 2.21756E−01 | −9.50997E−01 | −3.41959E−01 | −4.06993E−01 |
| A12 = | −1.96549E−01 | −3.20480E−01 | 1.33661E+00 | 4.04346E−01 | 1.76877E−01 |
| A14 = | 3.09094E−01 | 4.54891E−01 | −6.41280E−01 | −1.64379E−01 | |
| | Surface # | | | | |
| | 7 | 8 | 9 | 10 | 11 |
| k = | −7.00000E+01 | 3.13374E+00 | −3.38921E+00 | −3.17377E+01 | −6.29238E+00 |
| A4 = | −7.01595E−02 | 5.26926E−02 | −1.17719E−01 | −2.03689E−02 | −5.71305E−02 |
| A6 = | −1.19321E−01 | 5.39687E−02 | 1.29528E−01 | −2.49315E−02 | 1.68763E−02 |
| A8 = | 1.28755E−01 | −2.14317E−01 | −1.13258E−01 | 1.10370E−02 | −5.80209E−03 |
| A10 = | −6.72342E−02 | 3.09122E−01 | 6.75554E−02 | −1.11957E−03 | 1.45520E−03 |
| A12 = | 1.98922E−02 | −1.69648E−01 | −1.74327E−02 | −2.26507E−04 | −2.12925E−04 |
| A14 = | | 3.39351E−02 | 1.42593E−03 | 4.71248E−05 | 1.29124E−05 |

The equation of the aspheric surface profiles of the fourth embodiment has the same form as that of the first embodiment. Moreover, the description of the factors in the relations is as those set forth in the first embodiment, but the values of the relations of the fourth embodiment are listed in the following TABLE 11.

TABLE 11
(Embodiment 4)

| | | | |
|---|---|---|---|
| f | 4.25 | f1/f2 | −0.55 |
| Fno | 3.30 | f/f1 | 1.35 |
| HFOV | 32.3 | f/f3 | −0.09 |
| V1 − V2 | 34.9 | fL/f1 | −0.61 |
| (CT2 + CT3)/Td | 0.17 | \|Δf/f\| | 0.03 |
| \|ΔT12/T13\| | 0.12 | SD/TD | 0.88 |
| (R3 + R4)/(R3 − R4) | 1.49 | TTL/ImgH | 1.89 |
| RL/f | 0.23 | | |

### Embodiment 5

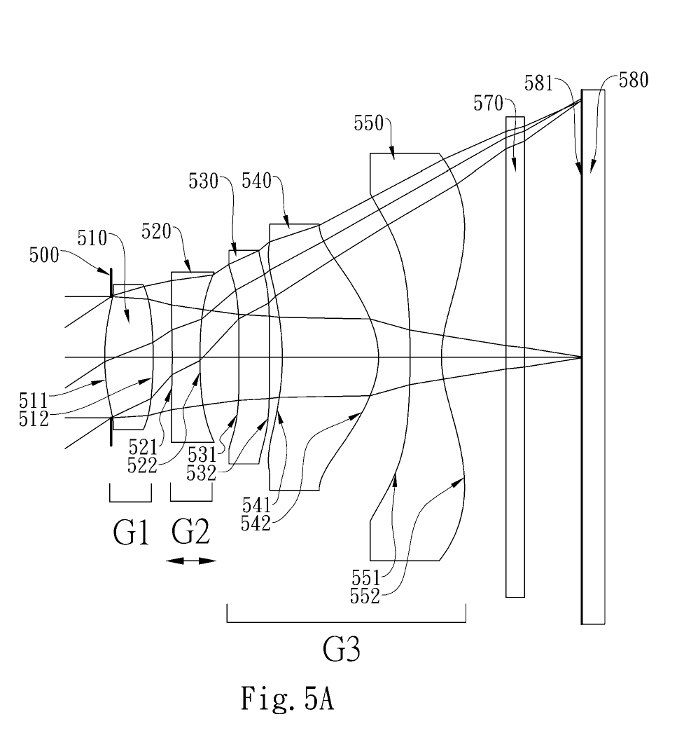

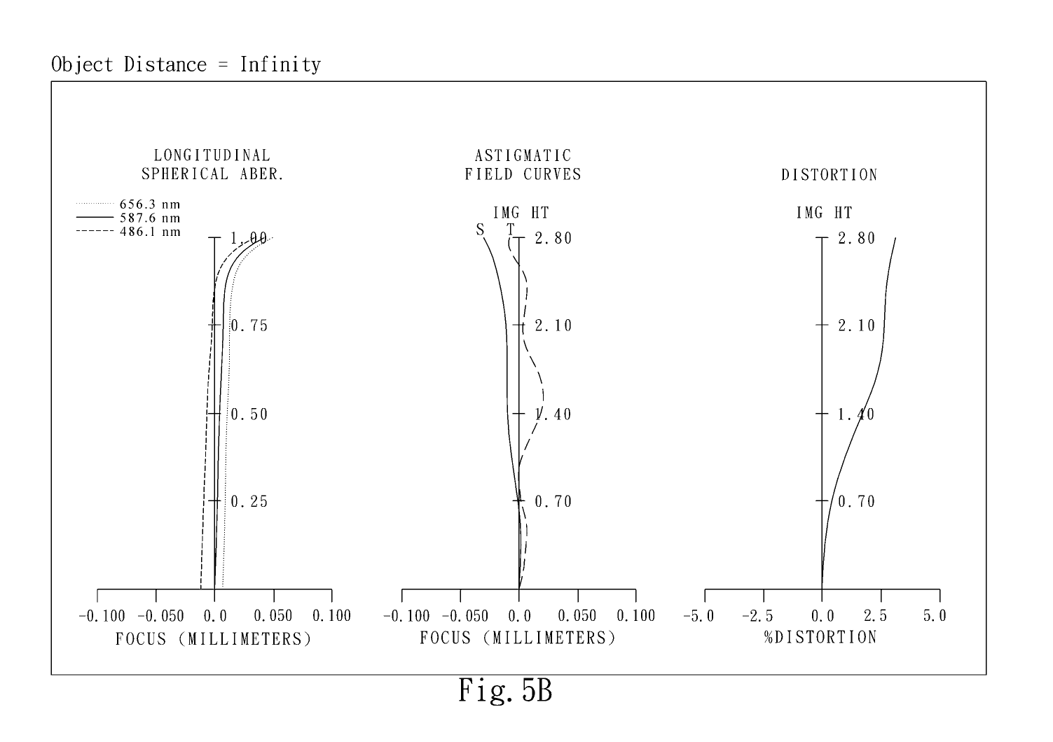

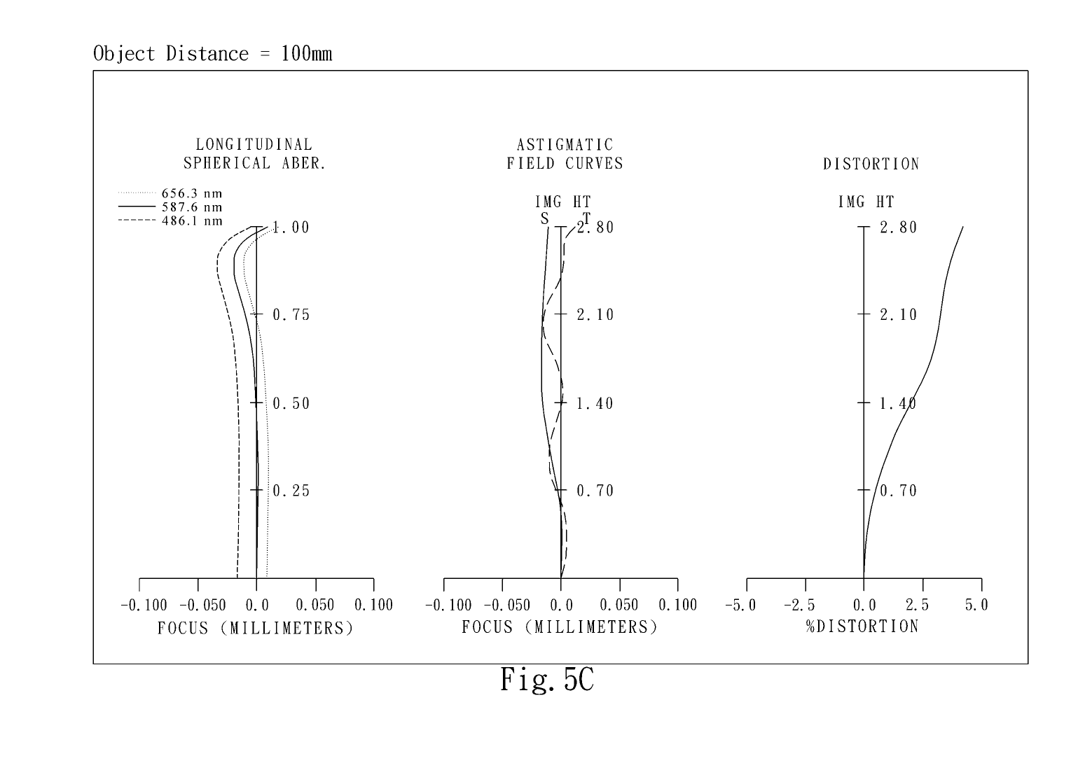

FIG. 5A shows an optical image lens assembly in accordance with the fifth embodiment of the present invention; meanwhile, FIG. 5B shows the aberration curves of the fifth embodiment as a distance between the assembly and an imaged object is infinite, and FIG. 5C shows the aberration curves as a distance between the assembly and the imaged object is 100 mm. The optical image lens assembly of the fifth embodiment of the present invention mainly comprises five lens elements, in order from an object side to an image side:

a first lens group G1, comprising a plastic first lens element 510 with positive refractive power having a convex object-side surface 511 and a convex image-side surface 512, the object-side and image-side surfaces 511 and 512 thereof being aspheric;

a second lens group G2, comprising a plastic second lens element 520 with negative refractive power having a concave object-side surface 521 and a concave image-side surface 522, the object-side and image-side surfaces 521 and 522 thereof being aspheric; and

a third lens group G3, comprising, in order from an object side to an image side:

a plastic third lens element 530 with negative refractive power having a convex object-side surface 531 and a concave image-side surface 532, the object-side and image-side surfaces 531 and 532 thereof being aspheric;

a plastic fourth lens element 540 with positive refractive power having a concave object-side surface 541 and a convex image-side surface 542, the object-side and image-side surfaces 541 and 542 thereof being aspheric; and

a plastic fifth lens element 550 with negative refractive power having a concave object-side surface 551 and a concave image-side surface 552, the object-side and image-side surfaces 551 and 552 thereof being aspheric, and at least one inflection point is formed on the image-side surface 552 thereof;

wherein an aperture stop 500 is disposed between an imaged object and the first lens element 510;

the optical image lens assembly further comprises an IR filter 570 disposed between the image-side surface 552 of the fifth lens element 550 and an image plane 581, and the IR filter 570 is made of glass and has no influence on the focal length of the optical image lens assembly; the optical image lens assembly further comprises an image sensor 580 provided on the image plane 581.

In the fifth embodiment of the present optical image lens assembly, a lens element with negative refractive power in the third lens group closest to the image plane 581 is the fifth lens element 550; a lens element with positive refractive power, which is adjacent to the object-side surface of the lens element closest to the image plane 581 in the third lens group, is the fourth lens element 540.

The detailed optical data of the fifth embodiment is shown in TABLE 12, and the aspheric surface data is shown in TABLE 13, wherein the units of the radius of curvature, the thickness and the focal length are expressed in mm, and HFOV is half of the maximal field of view.

TABLE 12
(Embodiment 5)
Object Distance = Infinity: f = 4.07 mm, Fno = 3.10, HFOV = 33.7 deg.

| | | | | | | | | Focal |
|---|---|---|---|---|---|---|---|---|
| Surface # | | Curvature Radius | | Thickness | Material | Index | Abbe # | length |
| 0 | Object | Plano | | Infinity, 100 | | | | |
| 1 | Ape. Stop | Plano | | −0.070 | | | | |
| 2 | Lens 1 | 2.160787 | (ASP) | 0.525 | Plastic | 1.544 | 55.9 | 2.87 |
| 3 | | −5.155092 | (ASP) | 0.207, 0.284 | | | | |
| 4 | Lens 2 | −10.494615 | (ASP) | 0.301 | Plastic | 1.633 | 23.4 | −5.33 |
| 5 | | 5.022998 | (ASP) | 0.423, 0.346 | | | | |
| 6 | Lens 3 | 62.445126 | (ASP) | 0.328 | Plastic | 1.633 | 23.4 | −81.84 |
| 7 | | 28.252359 | (ASP) | 0.143 | | | | |
| 8 | Lens 4 | −2.711647 | (ASP) | 1.044 | Plastic | 1.544 | 55.9 | 1.99 |
| 9 | | −0.878274 | (ASP) | 0.342 | | | | |
| 10 | Lens 5 | −9.645842 | (ASP) | 0.340 | Plastic | 1.530 | 55.8 | −1.96 |
| 11 | | 1.176892 | (ASP) | 0.700 | | | | |

| | | | | | | | |
|---|---|---|---|---|---|---|---|
| 12 | IR-filter | Plano | 0.200 | Glass | 1.517 | 64.2 | — |
| 13 | | Plano | 0.621 | | | | |
| 14 | Image | Plano | — | | | | |

* Reference wavelength is 587.6 nm (d-line)
* Object Distance = 100 mm: surface 3 thickness = 0.284 mm, surface 5 thickness = 0.346 mm, f = 3.99 mm

TABLE 13
Aspheric Coefficients

| | Surface # | | | | |
|---|---|---|---|---|---|
| | 2 | 3 | 4 | 5 | 6 |
| k = | −1.66286E+01 | −1.62255E+01 | −7.92533E+01 | 1.61262E+01 | 2.53657E+01 |
| A4 = | 1.46627E−01 | −7.85462E−02 | 8.97132E−02 | 9.48105E−02 | −1.28658E−01 |
| A6 = | −2.82000E−01 | −9.22532E−03 | −9.11573E−02 | −1.42018E−02 | −1.52479E−01 |
| A8 = | 1.79779E−01 | −2.53860E−01 | 2.58325E−01 | 9.16958E−02 | 4.01209E−01 |
| A10 = | −1.34696E−01 | 3.99041E−01 | −9.08827E−01 | −3.47262E−01 | −4.18852E−01 |
| A12 = | 1.31326E−01 | −3.87663E−01 | 1.29588E+00 | 4.05649E−01 | 1.82610E−01 |
| A14 = | −3.82640E−01 | 7.07599E−02 | −6.59428E−01 | −1.67019E−01 | |
| | Surface # | | | | |
| | 7 | 8 | 9 | 10 | 11 |
| k = | −7.01715E+01 | 2.88777E+00 | −3.27465E+00 | −8.72655E+01 | −7.38956E+00 |
| A4 = | −7.05360E−02 | 5.84297E−02 | −1.21146E−01 | −1.33704E−02 | −5.48198E−02 |
| A6 = | −1.14995E−01 | 5.62723E−02 | 1.31232E−01 | −3.21666E−02 | 1.53977E−02 |
| A8 = | 1.32603E−01 | −2.12253E−01 | −1.13562E−01 | 1.18093E−02 | −5.84573E−03 |
| A10 = | −6.13960E−02 | 3.09158E−01 | 6.73450E−02 | −8.20993E−04 | 1.50355E−03 |
| A12 = | 1.85447E−02 | −1.69801E−01 | −1.74071E−02 | −1.95999E−04 | −2.12242E−04 |
| A14 = | | 3.38158E−02 | 1.52716E−03 | 3.21972E−05 | 1.21327E−05 |

The equation of the aspheric surface profiles of the fifth embodiment has the same form as that of the first embodiment. Moreover, the description of the factors in the relations is as those set forth in the first embodiment, but the values of the relations of the fifth embodiment are listed in the following TABLE 14.

TABLE 14
(Embodiment 5)

| | | | |
|---|---|---|---|
| f | 4.07 | f1/f2 | −0.54 |
| Fno | 3.10 | f/f1 | 1.42 |
| HFOV | 33.7 | f/f3 | −0.05 |
| V1 − V2 | 32.5 | fL/f1 | −0.68 |
| (CT2 + CT3)/Td | 0.17 | \|Δf/f\| | 0.02 |
| \|ΔT12/T13\| | 0.08 | SD/TD | 0.98 |
| (R3 + R4)/(R3 − R4) | 0.35 | TTL/ImgH | 1.82 |
| RL/f | 0.29 | | |

### Embodiment 6

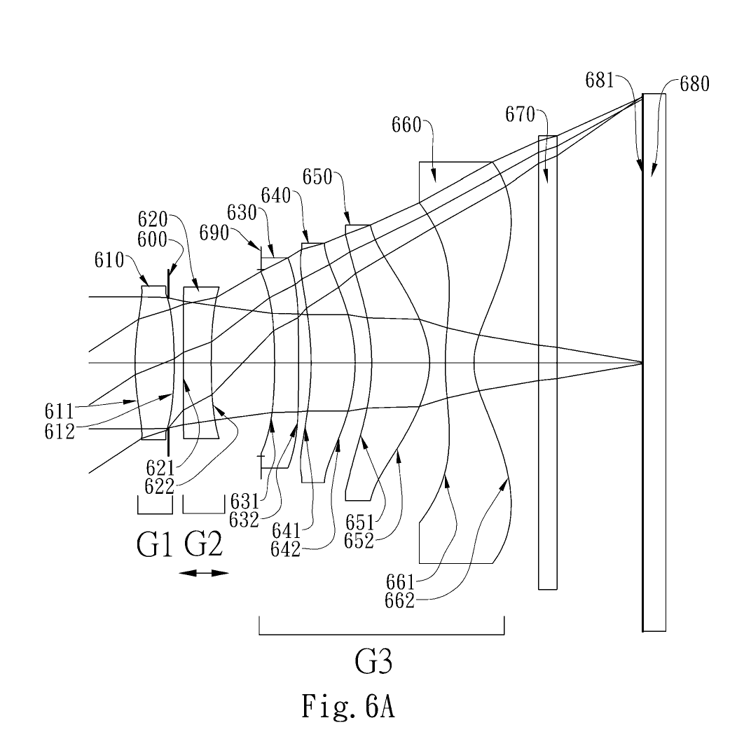

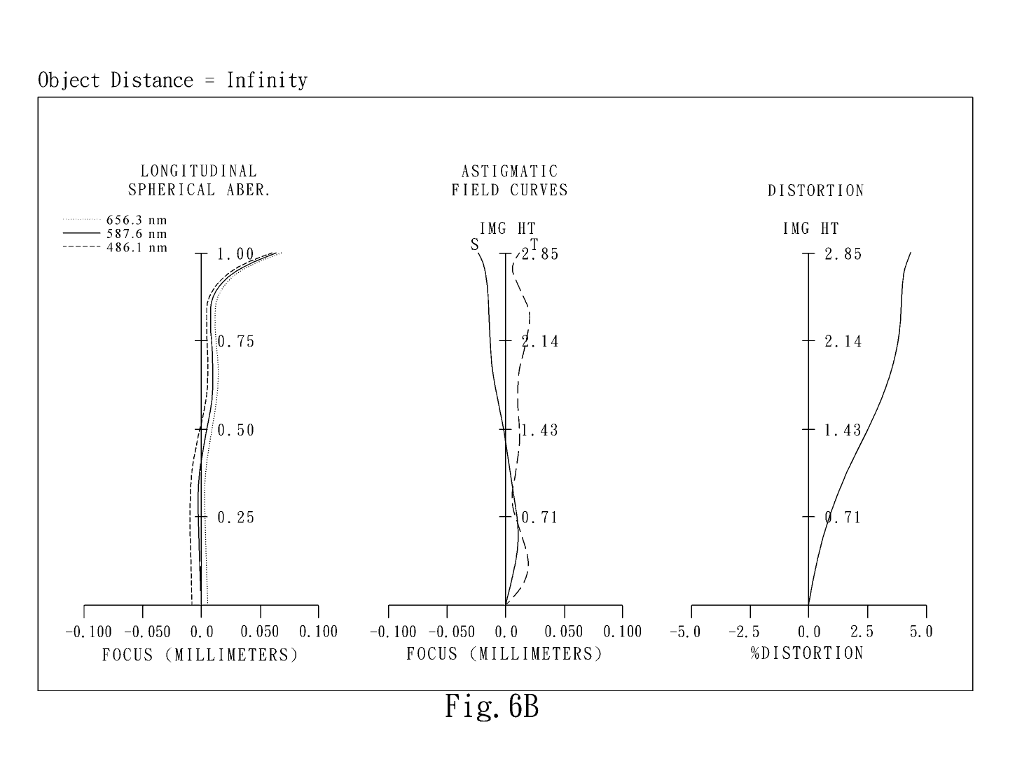

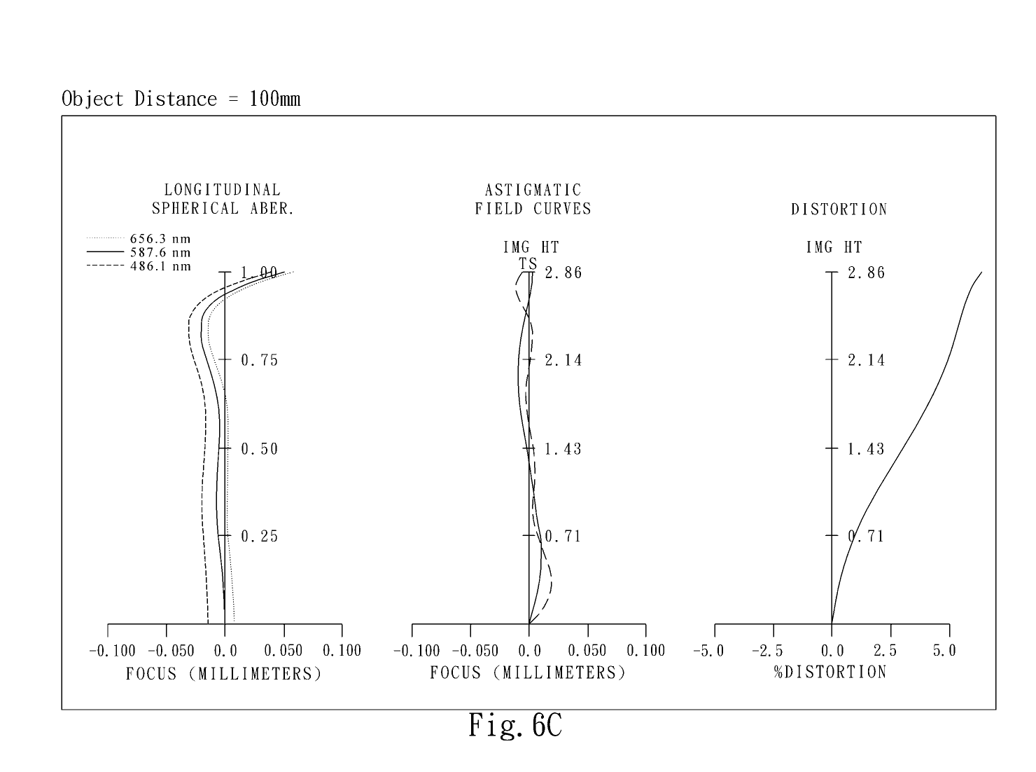

FIG. 6A shows an optical image lens assembly in accordance with the sixth embodiment of the present invention; meanwhile, FIG. 6B shows the aberration curves of the sixth embodiment as a distance between the assembly and an imaged object is infinite, and FIG. 6C shows the aberration curves as a distance between the assembly and the imaged object is 100 mm. The optical image lens assembly of the sixth embodiment of the present invention mainly comprises six lens elements, in order from an object side to an image side:

a first lens group G1, comprising a plastic first lens element 610 with positive refractive power having a convex object-side surface 611 and a convex image-side surface 612, the object-side and image-side surfaces 611 and 612 thereof being aspheric;

a second lens group G2, comprising a plastic second lens element 620 with negative refractive power having a concave object-side surface 621 and a concave image-side surface 622, the object-side and image-side surfaces 621 and 622 thereof being aspheric; and

a third lens group G3, comprising, in order from an object side to an image side:

a plastic third lens element 630 with negative refractive power having a concave object-side surface 631 and a convex image-side surface 632, the object-side and image-side surfaces 631 and 632 thereof being aspheric;

a plastic fourth lens element 640 with positive refractive power having a concave object-side surface 641 and a convex image-side surface 642, the object-side and image-side surfaces 641 and 642 thereof being aspheric;

a plastic fifth lens element 650 with positive refractive power having a concave object-side surface 651 and a convex image-side surface 652, the object-side and image-side surfaces 651 and 652 thereof being aspheric; and

a plastic sixth lens element 660 with negative refractive power having a convex object-side surface 661 and a concave image-side surface 662, the object-side and image-side surfaces 661 and 662 thereof being aspheric, and at least one inflection point is formed on both the object-side surface 661 and the image-side surface 662 thereof;

wherein an aperture stop 600 is disposed between the first lens element 610 and the second lens element 620; moreover, a further stop 690 is disposed between the second lens element 620 and the third lens element 630;

the optical image lens assembly further comprises an IR filter 670 disposed between the image-side surface 662 of the sixth lens element 660 and an image plane 681, and the IR filter 670 is made of glass and has no influence on the focal length of the optical image lens assembly; the optical image lens assembly further comprises an image sensor 680 provided on the image plane 681.

In the sixth embodiment of the present optical image lens assembly, a lens element with negative refractive power in the third lens group closest to the image plane 681 is the sixth lens element 660; a lens element with positive refractive power, which is adjacent to the object-side surface of the lens element closest to the image plane 681 in the third lens group, is the fifth lens element 650.

The detailed optical data of the sixth embodiment is shown in TABLE 15, and the aspheric surface data is shown in TABLE 16, wherein the units of the radius of curvature, the thickness and the focal length are expressed in mm, and HFOV is half of the maximal field of view.

TABLE 15
(Embodiment 6)
Object Distance = Infinity: f = 4.15 mm, Fno = 2.90, HFOV = 33.4 deg.

| | | | | | | | | Focal |
|---|---|---|---|---|---|---|---|---|
| Surface # | | Curvature Radius | | Thickness | Material | Index | Abbe # | length |
| 0 | Object | Plano | | Infinity, 100 | | | | |
| 1 | Lens 1 | 2.665023 | (ASP) | 0.424 | Plastic | 1.544 | 55.9 | 3.27 |
| 2 | | −5.038286 | (ASP) | −0.063 | | | | |
| 3 | Ape. Stop | Plano | | 0.163, 0.325 | | | | |
| 4 | Lens 2 | −18.181818 | (ASP) | 0.300 | Plastic | 1.634 | 23.8 | −7.49 |
| 5 | | 6.472125 | (ASP) | 0.688, 0.525 | | | | |
| 6 | Lens 3 | −6.950979 | (ASP) | 0.260 | Plastic | 1.634 | 23.8 | −13.06 |
| 7 | | −43.908606 | (ASP) | 0.136 | | | | |
| 8 | Lens 4 | −3.217106 | (ASP) | 0.477 | Plastic | 1.544 | 55.9 | 6.20 |
| 9 | | −1.732753 | (ASP) | 0.179 | | | | |
| 10 | Lens 5 | −2.329025 | (ASP) | 0.627 | Plastic | 1.544 | 55.9 | 2.26 |
| 11 | | −0.882438 | (ASP) | 0.170 | | | | |
| 12 | Lens 6 | 2.718929 | (ASP) | 0.310 | Plastic | 1.530 | 55.8 | −1.84 |
| 13 | | 0.690485 | (ASP) | 0.700 | | | | |

| | | | | | | | |
|---|---|---|---|---|---|---|---|
| 14 | IR-filter | Plano | 0.200 | Glass | 1.517 | 64.2 | — |
| 15 | | Plano | 0.930 | | | | |
| 16 | Image | Plano | — | | | | |

* Reference wavelength is 587.6 nm (d-line)
* Effective radius of surface 6(Stop) is 0.99 mm
* Object Distance = 100 mm: surface 3 thickness = 0.325 mm, surface 5 thickness = 0.525 mm, f = 4.06 mm

TABLE 16
Aspheric Coefficients

| Surface # | 1 | 2 | 4 | 5 | 6 | 7 |
|---|---|---|---|---|---|---|
| k = | −2.14517E+01 | −2.19482E+01 | 8.58617E+01 | 1.67039E+01 | −4.17813E+00 | 9.00000E+01 |
| A4 = | 8.71908E−02 | −8.54745E−02 | 6.68503E−02 | 7.43291E−02 | −4.91756E−02 | −8.27101E−03 |
| A6 = | −2.49984E−01 | −1.57375E−02 | −7.05272E−02 | −1.92409E−02 | −1.68722E−01 | −1.22481E−01 |
| A8 = | 2.42461E−01 | −1.34219E−01 | 3.01049E−01 | 8.71976E−02 | 3.64563E−01 | 1.26401E−01 |
| A10 = | −2.84419E−01 | 8.16575E−02 | −8.65642E−01 | −2.75215E−01 | −3.82541E−01 | −7.10301E−02 |
| A12 = | 1.37424E−02 | 2.52153E−02 | 1.23645E+00 | 3.84896E−01 | 1.54966E−01 | 1.79863E−02 |
| A14 = | 4.79334E−02 | −5.38511E−02 | −6.92497E−01 | −2.05896E−01 | | |
| Surface # | 8 | 9 | 10 | 11 | 12 | 13 |
| k = | 4.85051E+00 | −9.15455E−01 | −1.79192E+00 | −4.33313E+00 | −5.83677E+01 | −4.47988E+00 |
| A4 = | 6.93342E−02 | 2.85155E−02 | 1.37271E−02 | −1.18603E−01 | −5.54869E−02 | −7.64981E−02 |
| A6 = | 5.28110E−02 | 5.23518E−03 | 1.07067E−02 | 1.31360E−01 | −1.35947E−02 | 2.53477E−02 |
| A8 = | −2.18006E−01 | 4.17458E−03 | 1.09669E−03 | −1.15366E−01 | 9.22691E−03 | −7.46026E−03 |
| A10 = | 3.07051E−01 | 7.36544E−04 | −5.08221E−07 | 6.62859E−02 | −1.23182E−03 | 1.46920E−03 |
| A12 = | −1.69693E−01 | 4.11368E−04 | −7.46955E−04 | −1.75957E−02 | −2.28821E−04 | −1.78777E−04 |
| A14 = | 3.52375E−02 | | | 1.63380E−03 | 5.47723E−05 | 9.51238E−06 |

The equation of the aspheric surface profiles of the sixth embodiment has the same form as that of the first embodiment. Moreover, the description of the factors in the relations is as those set forth in the first embodiment, but the values of the relations of the sixth embodiment are listed in the following TABLE 17.

TABLE 17
(Embodiment 6)

| | | | |
|---|---|---|---|
| f | 4.15 | f1/f2 | −0.44 |
| Fno | 2.90 | f/f1 | 1.27 |
| HFOV | 33.4 | f/f3 | −0.32 |
| V1 − V2 | 32.1 | fL/f1 | −0.56 |
| (CT2 + CT3)/Td | 0.15 | \|Δf/f\| | 0.02 |
| \|ΔT12/T13\| | 0.14 | SD/TD | 0.90 |
| (R3 + R4)/(R3 − R4) | 0.47 | TTL/ImgH | 1.90 |
| RL/f | 0.17 | | |

### Embodiment 7

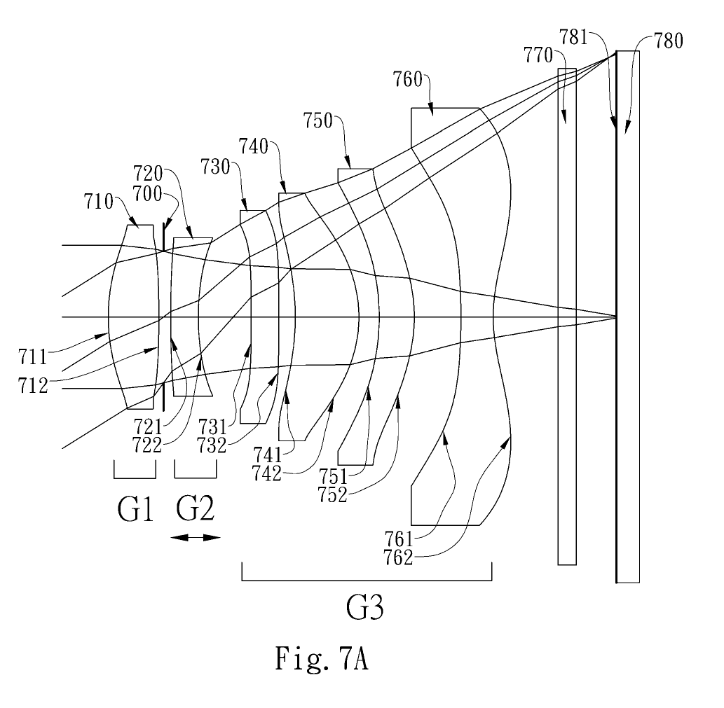

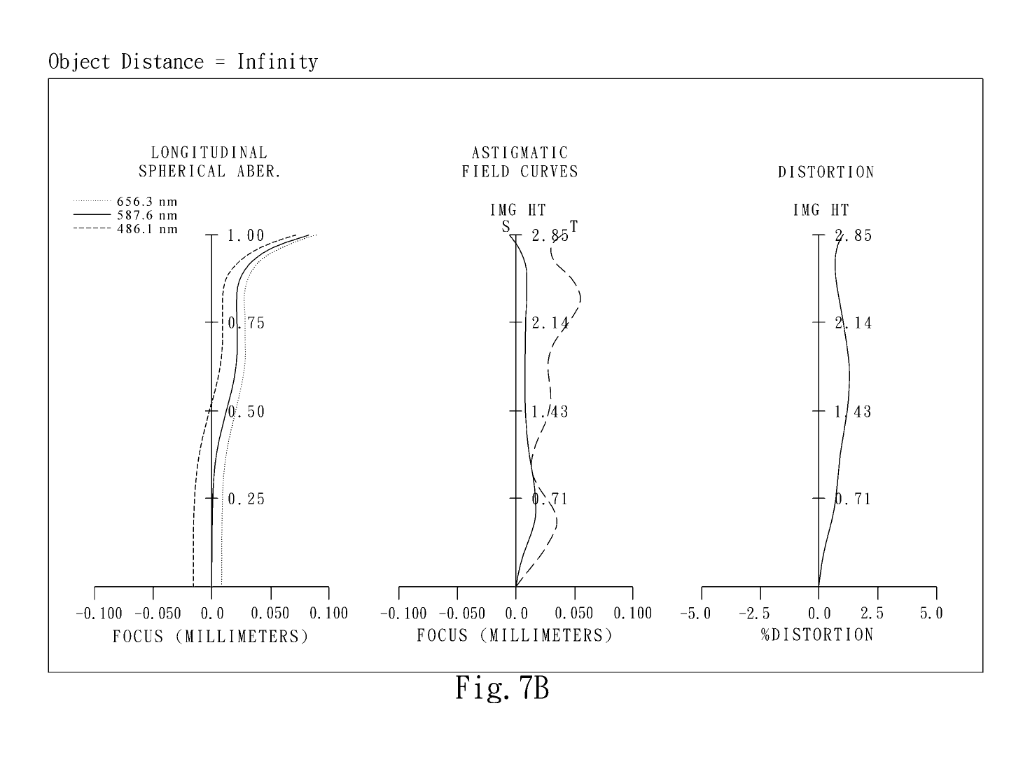

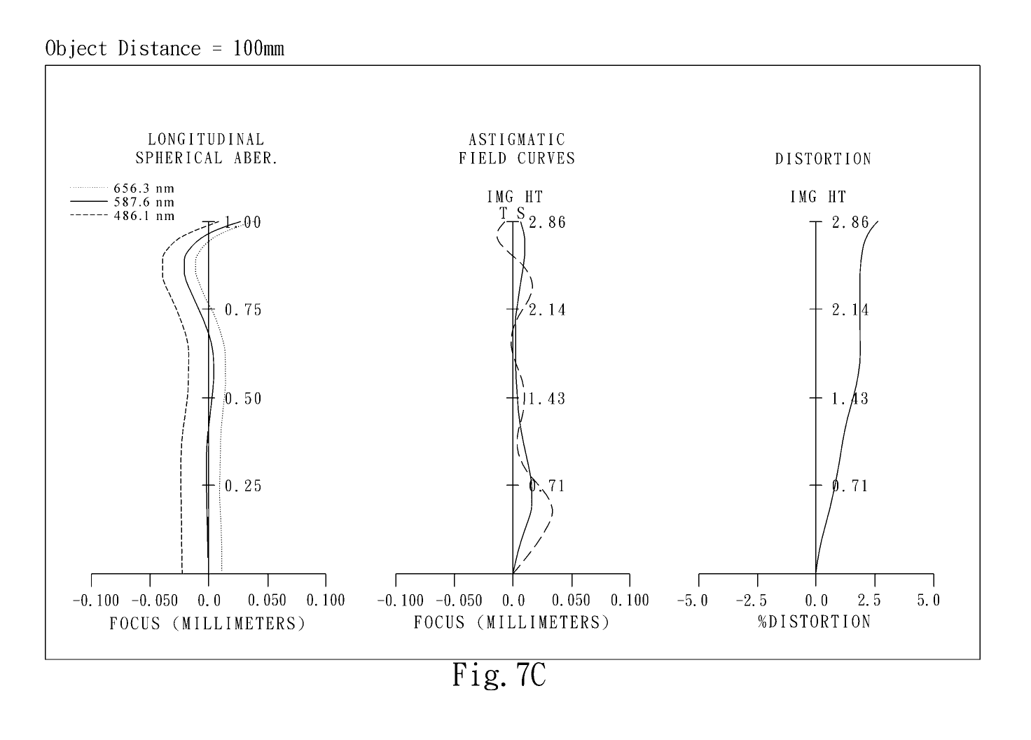

FIG. 7A shows an optical image lens assembly in accordance with the seventh embodiment of the present invention; meanwhile, FIG. 7B shows the aberration curves of the seventh embodiment as a distance between the assembly and an imaged object is infinite, and FIG. 7C shows the aberration curves as a distance between the assembly and the imaged object is 100 mm. The optical image lens assembly of the seventh embodiment of the present invention mainly comprises six lens elements, in order from an object side to an image side:

a first lens group G1, comprising a plastic first lens element 710 with positive refractive power having a convex object-side surface 711 and a convex image-side surface 712, the object-side and image-side surfaces 711 and 712 thereof being aspheric;

a second lens group G2, comprising a plastic second lens element 720 with negative refractive power having a convex object-side surface 721 and a concave image-side surface 722, the object-side and image-side surfaces 721 and 722 thereof being aspheric; and

a third lens group G3, comprising, in order from an object side to an image side:

a plastic third lens element 730 with positive refractive power having a convex object-side surface 731 and a convex image-side surface 732, the object-side and image-side surfaces 731 and 732 thereof being aspheric;

a plastic fourth lens element 740 with positive refractive power having a concave object-side surface 741 and a convex image-side surface 742, the object-side and image-side surfaces 741 and 742 thereof being aspheric;

a plastic fifth lens element 750 with positive refractive power having a concave object-side surface 751 and a convex image-side surface 752, the object-side and image-side surfaces 751 and 752 thereof being aspheric; and

a plastic sixth lens element 760 with negative refractive power having a concave object-side surface 761 and a concave image-side surface 762, the object-side and image-side surfaces 761 and 762 thereof being aspheric, and at least one inflection point is formed on the image-side surface 762 thereof;

wherein an aperture stop 700 is disposed between the first lens element 710 and the second lens element 720;

the optical image lens assembly further comprises an IR filter 770 disposed between the image-side surface 762 of the sixth lens element 760 and an image plane 781, and the IR filter 770 is made of glass and has no influence on the focal length of the optical image lens assembly; the optical image lens assembly further comprises an image sensor 780 provided on the image plane 781.

In the seventh embodiment of the present optical image lens assembly, a lens element with negative refractive power in the third lens group closest to the image plane 781 is the sixth lens element 760; a lens element with positive refractive power, which is adjacent to the object-side surface of the lens element closest to the image plane 781 in the third lens group, is the fifth lens element 750.

The detailed optical data of the seventh embodiment is shown in TABLE 18, and the aspheric surface data is shown in TABLE 19, wherein the units of the radius of curvature, the thickness and the focal length are expressed in mm, and HFOV is half of the maximal field of view.

TABLE 18
(Embodiment 7)
Object Distance = Infinity: f = 4.51 mm, Fno = 2.90, HFOV = 32.0 deg.

| | | | | | | | | Focal |
|---|---|---|---|---|---|---|---|---|
| Surface # | | Curvature Radius | | Thickness | Material | Index | Abbe # | length |
| 0 | Object | Plano | | Infinity, 100 | | | | |
| 1 | Lens 1 | 2.010363 | (ASP) | 0.548 | Plastic | 1.535 | 56.3 | 3.23 |
| 2 | | −11.026354 | (ASP) | 0.050 | | | | |
| 3 | Ape. Stop | Plano | | 0.077, 0.208 | | | | |
| 4 | Lens 2 | 13.349783 | (ASP) | 0.300 | Plastic | 1.634 | 23.8 | −5.75 |
| 5 | | 2.838205 | (ASP) | 0.570, 0.439 | | | | |
| 6 | Lens 3 | 110.500532 | (ASP) | 0.300 | Plastic | 1.634 | 23.8 | 97.36 |
| 7 | | −139.695702 | (ASP) | 0.180 | | | | |
| 8 | Lens 4 | −2.736578 | (ASP) | 0.690 | Plastic | 1.544 | 55.9 | 4.59 |
| 9 | | −1.421244 | (ASP) | 0.220 | | | | |
| 10 | Lens 5 | −2.394313 | (ASP) | 0.380 | Plastic | 1.544 | 55.9 | 8.51 |
| 11 | | −1.666667 | (ASP) | 0.505 | | | | |
| 12 | Lens 6 | −7.881022 | (ASP) | 0.350 | Plastic | 1.530 | 55.8 | −2.65 |
| 13 | | 1.733382 | (ASP) | 0.700 | | | | |

| | | | | | | | |
|---|---|---|---|---|---|---|---|
| 14 | IR-filter | Plano | 0.200 | Glass | 1.517 | 64.2 | — |
| 15 | | Plano | 0.434 | | | | |
| 16 | Image | Plano | — | | | | |

* Reference wavelength is 587.6 nm (d-line)
* Object Distance = 100 mm: surface 3 thickness = 0.208 mm, surface 5 thickness = 0.439 mm, f = 4.35 mm

TABLE 19
Aspheric Coefficients

| Surface # | 1 | 2 | 4 | 5 | 6 | 7 |
|---|---|---|---|---|---|---|
| k = | −1.26572E+01 | −7.23211E+01 | −6.97863E+01 | 7.05961E+00 | 9.00000E+01 | −9.00000E+01 |
| A4 = | 1.72674E−01 | −3.27467E−02 | 2.77145E−02 | −6.16999E−04 | −5.10391E−02 | 1.07330E−03 |
| A6 = | −2.26466E−01 | 4.51550E−02 | −5.05219E−02 | −2.50083E−02 | −1.82456E−01 | −1.48502E−01 |
| A8 = | 2.29855E−01 | −2.13106E−01 | 2.97791E−01 | 8.70087E−02 | 3.37698E−01 | 1.20630E−01 |
| A10 = | −1.88176E−01 | 2.85025E−01 | −8.78035E−01 | −3.21039E−01 | −4.14646E−01 | −6.48040E−02 |
| A12 = | 5.88369E−02 | −1.95835E−01 | 1.19585E+00 | 4.35737E−01 | 1.91736E−01 | 1.90405E−02 |
| A14 = | −7.55629E−03 | 5.09506E−02 | −6.47439E−01 | −2.59244E−01 | | |
| Surface # | 8 | 9 | 10 | 11 | 12 | 13 |
| k = | 3.10704E+00 | −4.90920E−01 | −7.97344E−02 | −9.90873E+00 | 1.45875E+01 | −6.81155E+00 |
| A4 = | 6.00080E−02 | 3.94974E−03 | 1.85420E−03 | −1.02768E−01 | −2.63640E−02 | −6.72595E−02 |
| A6 = | 4.82910E−02 | 1.57180E−02 | −4.54992E−03 | 1.23360E−01 | −2.18258E−02 | 2.11668E−02 |
| A8 = | −2.14690E−01 | −1.99040E−03 | 3.76398E−03 | −1.18066E−01 | 1.15824E−02 | −6.69041E−03 |
| A10 = | 3.07556E−01 | −5.23290E−04 | 1.21335E−03 | 6.63661E−02 | −1.04489E−03 | 1.48037E−03 |
| A12 = | −1.70054E−01 | 1.97535E−03 | −5.78335E−04 | −1.73674E−02 | −2.33129E−04 | −1.98583E−04 |
| A14 = | 3.49985E−02 | | | 1.66215E−03 | 4.15313E−05 | 1.14031E−05 |

The equation of the aspheric surface profiles of the seventh embodiment has the same form as that of the first embodiment. Moreover, the description of the factors in the relations is as those set forth in the first embodiment, but the values of the relations of the seventh embodiment are listed in the following TABLE 20.

TABLE 20
(Embodiment 7)

| | | | |
|---|---|---|---|
| f | 4.51 | f1/f2 | −0.56 |
| Fno | 2.90 | f/f1 | 1.40 |
| HFOV | 32.0 | f/f3 | 0.05 |
| V1 − V2 | 32.5 | fL/f1 | −0.82 |
| (CT2 + CT3)/Td | 0.14 | \|Δf/f\| | 0.03 |
| \|ΔT12/T13\| | 0.14 | SD/TD | 0.86 |
| (R3 + R4)/(R3 − R4) | 1.54 | TTL/ImgH | 1.90 |
| RL/f | 0.38 | | |

### Embodiment 8

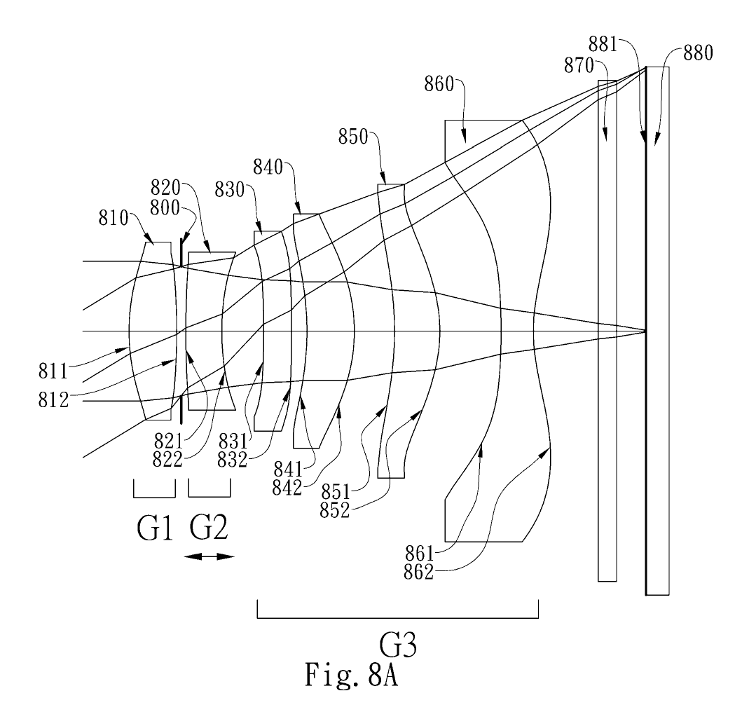

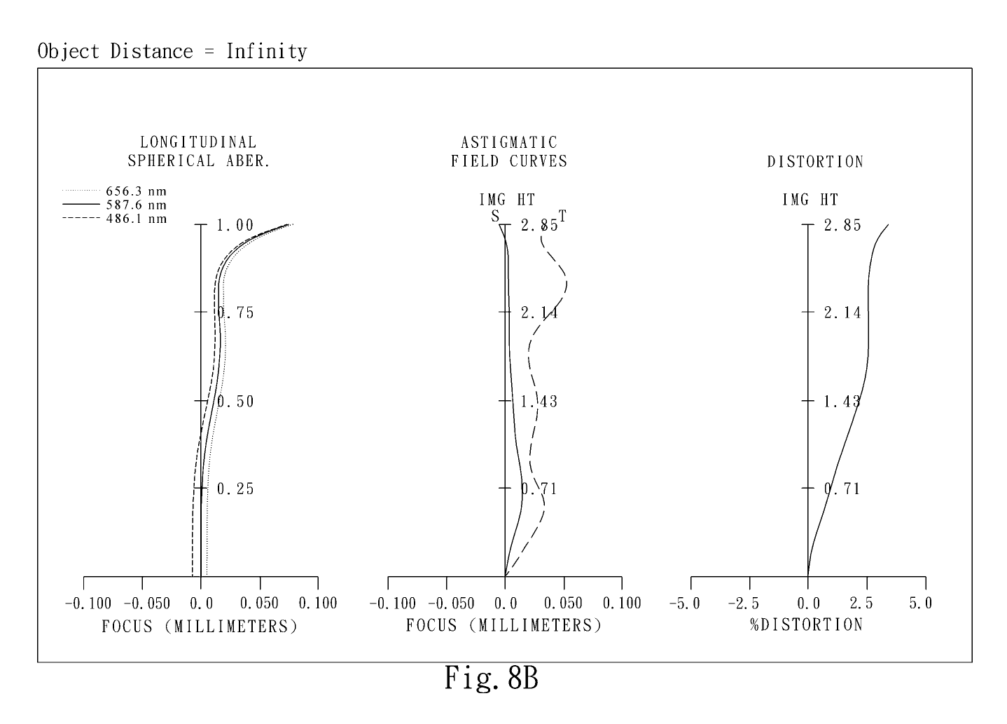

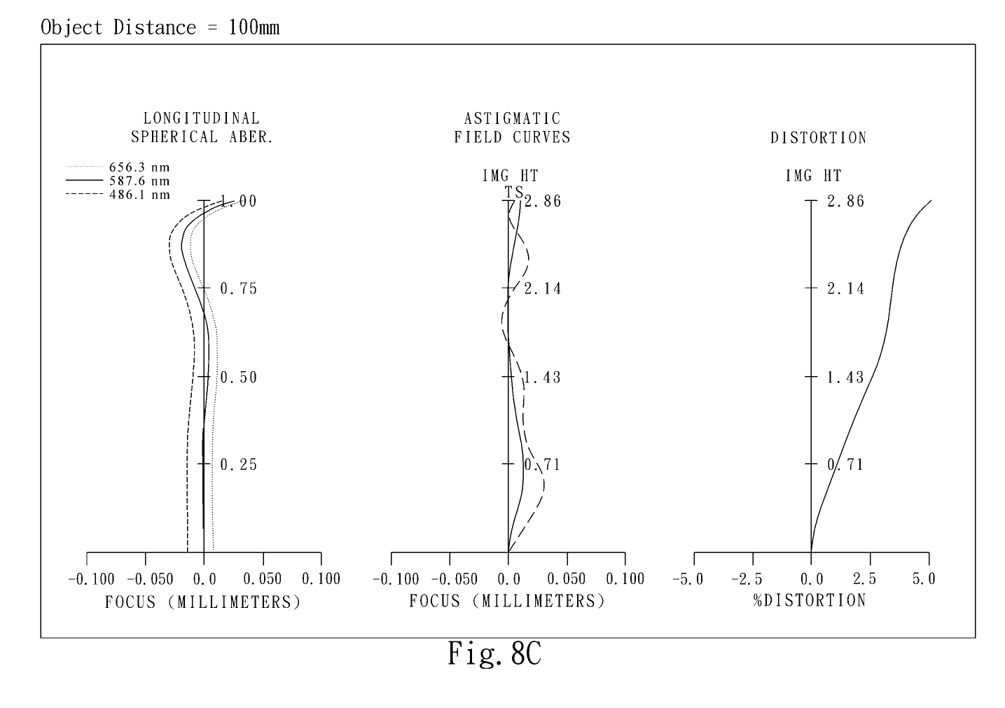

FIG. 8A shows an optical image lens assembly in accordance with the eighth embodiment of the present invention; meanwhile, FIG. 8B shows the aberration curves of the eighth embodiment as a distance between the assembly and an imaged object is infinite, and FIG. 8C shows the aberration curves as a distance between the assembly and the imaged object is 100 mm. The optical image lens assembly of the eighth embodiment of the present invention mainly comprises six lens elements, in order from an object side to an image side:

a first lens group G1, comprising a plastic first lens element 810 with positive refractive power having a convex object-side surface 811 and a convex image-side surface 812, the object-side and image-side surfaces 811 and 812 thereof being aspheric;

a second lens group G2, comprising a plastic second lens element 820 with negative refractive power having a convex object-side surface 821 and a concave image-side surface 822, the object-side and image-side surfaces 821 and 822 thereof being aspheric; and

a third lens group G3, comprising, in order from an object side to an image side:

a plastic third lens element 830 with negative refractive power having a concave object-side surface 831 and a convex image-side surface 832, the object-side and image-side surfaces 831 and 832 thereof being aspheric;

a plastic fourth lens element 840 with positive refractive power having a concave object-side surface 841 and a convex image-side surface 842, the object-side and image-side surfaces 841 and 842 thereof being aspheric;

a plastic fifth lens element 850 with positive refractive power having a concave object-side surface 851 and a convex image-side surface 852, the object-side and image-side surfaces 851 and 852 thereof being aspheric; and

a plastic sixth lens element 860 with negative refractive power having a concave object-side surface 861 and a concave image-side surface 862, the object-side and image-side surfaces 861 and 862 thereof being aspheric, and at least one inflection point is formed on the image-side surface 862 thereof;

wherein an aperture stop 800 is disposed between the first lens element 810 and the second lens element 820;

the optical image lens assembly further comprises an IR filter 870 disposed between the image-side surface 862 of the sixth lens element 860 and an image plane 881, and the IR filter 870 is made of glass and has no influence on the focal length of the optical image lens assembly; the optical image lens assembly further comprises an image sensor 880 provided on the image plane 881.

In the eighth embodiment of the present optical image lens assembly, a lens element with negative refractive power in the third lens group closest to the image plane 881 is the sixth lens element 860; a lens element with positive refractive power, which is adjacent to the object-side surface of the lens element closest to the image plane 881 in the third lens group, is the fifth lens element 850.

The detailed optical data of the eighth embodiment is shown in TABLE 21, and the aspheric surface data is shown in TABLE 22, wherein the units of the radius of curvature, the thickness and the focal length are expressed in mm, and HFOV is half of the maximal field of view.

TABLE 21
(Embodiment 8)
Object Distance = Infinity: f = 4.54 mm, Fno = 3.00, HFOV = 31.2 deg.

| | | | | | | | | Focal |
|---|---|---|---|---|---|---|---|---|
| Surface # | | Curvature Radius | | Thickness | Material | Index | Abbe # | length |
| 0 | Object | Plano | | Infinity, 100 | | | | |
| 1 | Lens 1 | 2.169054 | (ASP) | 0.516 | Plastic | 1.535 | 56.3 | 3.30 |
| 2 | | −8.689288 | (ASP) | 0.050 | | | | |
| 3 | Ape. Stop | Plano | | 0.050, 0.198 | | | | |
| 4 | Lens 2 | 11.486124 | (ASP) | 0.390 | Plastic | 1.633 | 23.4 | −5.90 |
| 5 | | 2.779254 | (ASP) | 0.453, 0.305 | | | | |
| 6 | Lens 3 | −13.987290 | (ASP) | 0.300 | Plastic | 1.633 | 23.4 | −41.58 |
| 7 | | −30.108113 | (ASP) | 0.170 | | | | |
| 8 | Lens 4 | −3.086537 | (ASP) | 0.514 | Plastic | 1.543 | 56.5 | 7.49 |
| 9 | | −1.858634 | (ASP) | 0.436 | | | | |
| 10 | Lens 5 | −3.429618 | (ASP) | 0.491 | Plastic | 1.514 | 56.8 | 5.41 |
| 11 | | −1.609618 | (ASP) | 0.663 | | | | |
| 12 | Lens 6 | −7.969104 | (ASP) | 0.350 | Plastic | 1.514 | 56.8 | −2.97 |
| 13 | | 1.914206 | (ASP) | 0.700 | | | | |

| | | | | | | | |
|---|---|---|---|---|---|---|---|
| 14 | IR-filter | Plano | 0.200 | Glass | 1.517 | 64.2 | — |
| 15 | | Plano | 0.320 | | | | |
| 16 | Image | Plano | — | | | | |

* Reference wavelength is 587.6 nm (d-line)
* Object Distance = 100 mm: surface 3 thickness = 0.198 mm, surface 5 thickness = 0.305 mm, f = 4.37 mm

TABLE 22
Aspheric Coefficients

| Surface # | 1 | 2 | 4 | 5 | 6 | 7 |
|---|---|---|---|---|---|---|
| k = | −1.47731E+01 | −2.71048E+01 | −7.32525E+01 | 6.68523E+00 | −9.00000E+01 | 9.00000E+01 |
| A4 = | 1.60213E−01 | −2.52207E−02 | 2.21910E−02 | −1.10337E−02 | −3.89795E−02 | 9.43396E−03 |
| A6 = | −2.20460E−01 | 3.37258E−02 | −4.73998E−02 | −2.78922E−02 | −1.75385E−01 | −1.61299E−01 |
| A8 = | 2.32997E−01 | −1.88170E−01 | 2.85626E−01 | 8.56425E−02 | 3.20806E−01 | 1.29935E−01 |
| A10 = | −1.96212E−01 | 2.80779E−01 | −8.51467E−01 | −3.14076E−01 | −4.02305E−01 | −5.94417E−02 |
| A12 = | 5.72090E−02 | −2.52604E−01 | 1.16511E+00 | 4.25989E−01 | 2.01946E−01 | 1.74575E−02 |
| A14 = | −2.82519E−03 | 1.04250E−01 | −6.31022E−01 | −2.53484E−01 | | |
| Surface # | 8 | 9 | 10 | 11 | 12 | 13 |
| k = | 4.07485E+00 | −7.21290E−01 | −6.99814E+00 | −8.31765E+00 | 1.53069E+01 | −5.20431E+00 |
| A4 = | 4.63247E−02 | −9.76002E−04 | 1.83163E−02 | −1.02467E−01 | −4.04820E−02 | −7.41021E−02 |
| A6 = | 5.40604E−02 | 1.75803E−02 | −9.89580E−03 | 1.31218E−01 | −2.12026E−02 | 2.34096E−02 |
| A8 = | −2.13367E−01 | −1.81469E−03 | 5.31785E−03 | −1.17948E−01 | 1.17916E−02 | −7.05347E−03 |
| A10 = | 3.07592E−01 | −1.66574E−03 | 1.71875E−03 | 6.60354E−02 | −1.01993E−03 | 1.49514E−03 |
| A12 = | −1.70236E−01 | 1.43216E−03 | −1.02512E−03 | −1.74220E−02 | −2.31449E−04 | −1.89511E−04 |
| A14 = | 3.43897E−02 | | | 1.67614E−03 | 4.66697E−05 | 1.03604E−05 |

The equation of the aspheric surface profiles of the eighth embodiment has the same form as that of the first embodiment. Moreover, the description of the factors in the relations is as those set forth in the first embodiment, but the values of the relations of the eighth embodiment are listed in the following TABLE 23.

TABLE 23
(Embodiment 8)

| | | | |
|---|---|---|---|
| f | 4.54 | f1/f2 | −0.56 |
| Fno | 3.00 | f/f1 | 1.38 |
| HFOV | 31.2 | f/f3 | −0.11 |
| V1 − V2 | 32.9 | fL/f1 | −0.90 |
| (CT2 + CT3)/Td | 0.16 | \|Δf/f\| | 0.04 |
| \|ΔT12/T13\| | 0.17 | SD/TD | 0.87 |
| (R3 + R4)/(R3 − R4) | 1.64 | TTL/ImgH | 1.94 |
| RL/f | 0.42 | | |

It is to be noted that TABLES 1-23 show different data of the different embodiments, however, the data of the different embodiments are obtained from experiments. Therefore, any optical image lens assembly of the same structure is considered to be within the scope of the present invention even if it uses different data.

What is claimed is:

1. An optical image lens assembly comprising, in order from an object side to an image side:
a first lens group comprising a first lens element with positive refractive power;
a second lens group comprising a second lens element with negative refractive power; and
a third lens group comprising at least three lens elements with refractive power;
wherein a lens element closest to an image plane in the third lens group has negative refractive power and a concave image-side surface;
wherein while a distance between an imaged object and the optical image lens assembly changes from far to near, focusing is performed by moving the second lens group along an optical axis toward the image plane;
wherein there are no more than seven lens elements with refractive power in the optical image lens assembly; a focal length of the optical image lens assembly is f, a focal length of the first lens element is f1, and they satisfy the following relation:
0.8<f/f1<2.0.

2. The optical image lens assembly according to claim 1, wherein a difference of the focal lengths of the optical image lens assembly between the second lens element is at the closest and the farthest position to the image plane is ^{Δ}f, the focal length of the optical image lens assembly is f, and they satisfy the following relation:

|^{Δ}f/f|<0.1.

3. The optical image lens assembly according to claim 2, wherein at least one inflection point is formed on the image-side surface of the lens element closest to the image plane in the third lens group.

4. The optical image lens assembly according to claim 3, wherein a lens element with positive refractive power closest to the image plane in the third lens group has a concave object-side surface and a convex image-side surface.

5. The optical image lens assembly according to claim 4, wherein a difference of an axial distance between the first lens element and the second lens element while the second lens element is at the closest and the farthest position to the image plane is ^{Δ}T12, a lens element in the third lens group closest to the imaged object is a third lens element, an axial distance between the first lens element and the third lens element is T13, and they satisfy the following relation:
0.02<|^{Δ}T12/T13|<0.4.

6. The optical image lens assembly according to claim 5, wherein the focal length of the optical image lens assembly is f, a focal length of the third lens element is f3, and they satisfy the following relation:
−0.5<f/f3<0.5.

7. The optical image lens assembly according to claim 5, wherein the focal length of the first lens element is f1, a focal length of the second lens element is f2, and they satisfy the following relation:
−0.7<f1/f2<−0.4.

8. The optical image lens assembly according to claim 5, wherein a radius of curvature of the image-side surface of the lens element closest to the image plane in the third lens group is RL, the focal length of the optical image lens assembly is f, and they satisfy the following relation:
0.1<RL/f<0.5.

9. The optical image lens assembly according to claim 6, wherein the focal length of the optical image lens assembly is f, the focal length of the third lens element is f3, and they satisfy the following relation:
−0.2<f/f3<0.2.

10. The optical image lens assembly according to claim 6, further comprising a stop, an axial distance between the stop and the image-side surface of the lens element closet to the image plane in the third lens group is Sd, an axial distance between an object-side surface of the first lens element and the image-side surface of the lens element closest to the image plane in the third lens group is Td, and they satisfy the following relation:
0.75<Sd/Td<1.10.

11. The optical image lens assembly according to claim 3, wherein a thickness of the second lens element on the optical axis is CT2, a lens element in the third lens group closest to the imaged object is a third lens element and a thickness thereof on the optical axis is CT3, an axial distance between an object-side surface of the first lens element and the image-side surface of the lens element closest to the image plane in the third lens group is Td, and they satisfy the following relation:
0.10<(CT2+CT3)/Td<0.22.

12. The optical image lens assembly according to claim 3, wherein a focal length of the lens element closest to the image plane in the third lens group is fL, the focal length of the first lens element is f1, and they satisfy the following relation:
−1.1<fL/f1<−0.4.

13. The optical image lens assembly according to claim 12, wherein an Abbe number of the first lens element is V1, an Abbe number of the second lens element is V2, and they satisfy the following relation:
25<V1−V2<42.

14. The optical image lens assembly according to claim 12, wherein a radius of curvature of an object-side surface of the second lens element is R3, a radius of curvature of an image-side surface of the second lens element is R4, and they satisfy the following relation:
0.0<(R3+R4)/(R3−R4)<2.0.

15. The optical image lens assembly according to claim 2, further comprising an image sensor on the image plane; an axial distance between the object-side surface of the first lens element and the image plane is TTL, half of a diagonal length of an effective photosensitive area of the image sensor is ImgH, and they satisfy the following relation:
TTL/ImgH<2.2.

16. An optical image lens assembly comprising, in order from an object side to an image side:
a first lens group comprising a first lens element with positive refractive power having a convex object-side surface;
a second lens group comprising a second lens element with negative refractive power having a concave image-side surface; and
a third lens group comprising at least three lens elements with refractive power;
wherein a lens element in the third lens group closest to an image plane has negative refractive power, a concave image-side surface and at least one inflection point is formed on the image-side surface thereof;
wherein the third lens group also comprises a lens element with positive refractive power having a concave object-side surface and a convex image-side surface, which is adjacent to an object-side surface of the lens element in the third lens group closest to the image plane;
wherein while a distance between an imaged object and the optical image lens assembly changes from far to near, focusing is performed by moving the second lens group along an optical axis toward the image plane;
wherein there are no more than seven lens elements with refractive power in the optical image lens assembly; a difference of the focal lengths of the optical image lens assembly between the second lens element is at the closest and the farthest position to the image plane is ^{Δ}f, the focal length of the optical image lens assembly is f, and they satisfy the following relation:

|^{Δ}f/f1<0.1.

17. The optical image lens assembly according to claim 16, wherein there are no more than four lens elements with refractive power in the third lens group.

18. The optical image lens assembly according to claim 17, wherein there are three lens elements with refractive power in the third lens group.

19. The optical image lens assembly according to claim 17, wherein a difference of an axial distance between the first lens element and the second lens element while the second lens element is at the closest and the farthest position to the image plane is ^{Δ}T12, a lens element in the third lens group closest to the imaged object is a third lens element, an axial distance between the first lens element and the third lens element is T13, and they satisfy the following relation:
0.02<|^{Δ}T12/T13|<0.4.

20. The optical image lens assembly according to claim 18, wherein an Abbe number of the first lens element is V1, an Abbe number of the second lens element is V2, and they satisfy the following relation:
25<V1−V2<42.

21. The optical image lens assembly according to claim 18, wherein the focal length of the optical image lens assembly is f, a lens element in the third lens group closest to the imaged object is a third lens element and a focal length thereof is f3, and they satisfy the following relation:
−0.2<f/f3<0.2.

22. The optical image lens assembly according to claim 18, wherein a thickness of the second lens element on the optical axis is CT2, a lens element in the third lens group closest to the imaged object is a third lens element and a thickness thereof on the optical axis is CT3, an axial distance between an object-side surface of the first lens element and the image-side surface of the lens element closest to the image plane in the third lens group is Td, and they satisfy the following relations:
0.10<(CT2+CT3)/Td<0.22.

23. The optical image lens assembly according to claim 18, further comprising a stop, an axial distance between the stop and the image-side surface of the lens element closest to the image plane in the third lens group is Sd, an axial distance between an object-side surface of the first lens element and the image-side surface of the lens element closest to the image plane in the third lens group is Td, the focal length of the optical image lens assembly is f, a focal length of the first lens element is f1, and they satisfy the following relations:
0.75<Sd/Td<1.10; and
1.2<f/f1<1.6.
